(19) United States
(12) Patent Application Publication
(10) Pub. No.: US 2025/0189980 A1
(43) Pub. Date: Jun. 12, 2025

(54) AUTOMATIC-DRIVING ASSISTING APPARATUS, AUTOMATIC-DRIVING ASSISTING SYSTEM, MONITORING APPARATUS, AND AUTOMATIC-DRIVING ASSISTING METHOD FOR MOBILE BODY

(71) Applicant: Mitsubishi Electric Corporation, Tokyo (JP)

(72) Inventors: Sara HIROSE, Tokyo (JP); Keisuke MORITA, Tokyo (JP); Yuta WADA, Tokyo (JP)

(73) Assignee: Mitsubishi Electric Corporation, Tokyo (JP)

(21) Appl. No.: 18/826,396

(22) Filed: Sep. 6, 2024

(30) Foreign Application Priority Data
Dec. 8, 2023 (JP) 2023-207634

(51) Int. Cl. G05D 1/639; G05D 105/28; G05D 107/70

(52) U.S. Cl. CPC G05D 1/639; G05D 2105/28; G05D 2107/70

(57) ABSTRACT

An automatic-driving assisting apparatus comprises a working-information obtainer that obtains a target position and a command for working, an obstacle state obtainer that obtains an obstacle state hindering moving to a target position and working, an obstacle state determiner that determines a level of an obstacle state, and an assist requester that makes an assist request, when a level is either a second level at which an automatic driving is continued under monitoring by a remote-monitoring person, a third level at which driving of a mobile body is performed through remote driving, or a fourth level at which dispatch of a dispatch worker for performing manual operation is requested.

### INCORPORATION BY REFERENCE

The disclosure of Japanese Patent Application No. 2023-207634 filed on Dec. 8, 2023 including its specification, claims and drawings, is incorporated herein by reference in its entirety.

### BACKGROUND

The present disclosure relates to an automatic-driving assisting apparatus, an automatic-driving assisting system, a monitoring apparatus, and an automatic-driving assisting method for mobile bodies such as a traction vehicle and a forklift.

In recent years, the work of conveying and transporting cargos packed in a trailer by a traction vehicle such as a tractor, the work of transporting cargos conveyed by a track by a forklift become important in logistics. For example, goods conveyed by a trailer are stored in a facility such as a distribution center having a parking place where a great number of trailers can be parked. In the distribution center, a trailer is hitched to a tractor and then the tractor tows and conveys the trailer to the carry-in port of a building. The trailer is docked in the carry-in port and the goods are conveyed into the building. Part of these peculiar works are automated so that the efficiency of the work of conveying goods or the like is raised.

Patent Document 1 has disclosed control in which an autonomous tractor is made to move to the position of a trailer situated at a pickup spot and is hitched to the trailer. It is described that in the case where after that, an obstacle is detected, support from an operator or a remote apparatus is given. In addition, Patent Document 2 describes that in the case where an ordinary automatic-driving vehicle has a difficulty in continuing automatic driving, remote operation or remote driving of the automatic-driving vehicle is requested.
Patent Document 1: Publication Number US 2022/0410898 A1
Patent Document 2: Publication Number JP 2022-188661 A

### SUMMARY

However, there are a great number of factors that hinder automatic-driving operation, such as a fact that because a trailer as a cargo-loading vehicle is parked largely off a parking line, it is difficult to hitch the tractor to the trailer in a preliminarily set traveling route and a fact that because the distance between a trailer and another trailer parked in the adjacent parking zone is small, unparking after hitching is difficult. When it is tried to automate the operation items including operation for avoiding the foregoing factors, the setting becomes complicated; thus, it cannot be helped that in order to solve the problem, a person in charge is eventually dispatched to the spot, and hence there has been a problem that the load on the person in charge is large.

The present disclosure has been implemented in order to solve the foregoing problem; the objective thereof is to provide an automatic-driving assisting apparatus for a mobile body that can flexibly cope with works of conveying and transporting cargos loaded on a cargo-loading vehicle and can reduce the load on a person in charge. In addition, the objective thereof is to provide an automatic-driving assisting system, a monitoring apparatus, and an automatic-driving assisting method.

An automatic-driving assisting apparatus for a mobile body according to the present disclosure is the one that assists driving of a mobile body that moves cargos in a facility where conveyed cargos are stored; the automatic-driving assisting apparatus includes a working-information obtaining unit that obtains a target position and a command for working,
an obstacle state obtaining unit that obtains an obstacle state hindering automatic-driving operation for at least any one of moving to a target position and working,
an obstacle state determination unit that determines to which one of levels an obstacle state obtained by the obstacle state obtaining unit belongs, wherein the levels are the first level at which an obstacle is avoided by automatic driving of the mobile body, the second level at which while the automatic driving is continued under monitoring by the remote-monitoring person, the remote-monitoring person is made to perform automatic-driving assisting operation, the third level at which driving of the mobile body is performed through remote driving, and the fourth level at which dispatch of the dispatch worker for performing manual operation is requested, and
an assist requesting unit that makes an assist request, when the obstacle state determination unit determines that the obstacle state belongs to any one of the second level, the third level, and the fourth level.

In addition, an automatic-driving assisting system for a mobile body according to the present disclosure includes
the automatic-driving assisting apparatus for a mobile body, mounted in a mobile body, according to the present disclosure, and
a monitoring apparatus having
a positional-information obtaining unit that obtains respective positional information items on a cargo-loading vehicle on which the cargos are loaded and the mobile body,
a command unit that selects a subject cargo-loading vehicle among two or more cargo-loading vehicles and then issues a command for making the mobile body move to the parking position of the subject cargo-loading vehicle and carry cargos, and
an assist-performing unit that responds to assist requests in such a way as to remotely operate the mobile body, when an assist for remote operation is requested by the automatic-driving assisting apparatus, to remotely drive the mobile body, when an assist for remote driving is requested, and to request dispatch of a dispatch worker, when a dispatch request for a dispatch worker who performs manual operation is made.

In addition, another automatic-driving assisting system for a mobile body according to the present disclosure includes
the automatic-driving assisting apparatus for a mobile body, mounted in a mobile body, according to the present disclosure having
   a command inputting unit for inputting a target position and a command for working,
   a positional-information comprehending unit that comprehends the target position,
   an action plan generation unit that generates an action plan, based on working information inputted by the command inputting unit and positional information for the target position comprehended by the positional-information comprehending unit, and making the mobile body perform the automatic-driving operation, based on the generated action plan, and
a monitoring apparatus having
   an assist-performing unit that responds to assist requests in such a way as to remotely operate the mobile body, when an assist for remote operation is requested by the automatic-driving assisting apparatus, to remotely drive the mobile body, when an assist for remote driving is requested, and to request dispatch of a dispatch worker, when an assist for manual operation is requested.

In addition, a monitoring apparatus for a mobile body according to the present disclosure includes
the automatic-driving assisting apparatus for a mobile body according to the present disclosure, a positional-information obtaining unit that obtains respective positional information items on a cargo-loading vehicle on which the cargos are loaded and the mobile body,
a command unit that selects a subject cargo-loading vehicle among two or more cargo-loading vehicles and then issues a command for making the mobile body move to the parking position of the subject cargo-loading vehicle and carry cargos, and
an assist-performing unit that responds to assist requests in such a way as to remotely operate the mobile body, when an assist for remote operation is requested by the automatic-driving assisting apparatus, to remotely drive the mobile body, when an assist for remote driving is requested, and to request dispatch of a dispatch worker, when a dispatch request for a dispatch worker who performs manual operation is made.

An automatic-driving assisting method for a mobile body according to the present disclosure is the one that assists driving of a mobile body that moves cargos in a facility where conveyed cargos are stored; the automatic-driving assisting method includes
a step of obtaining a target position and a command for working,
a step of obtaining an obstacle state hindering automatic-driving operation for at least any one of moving to a target position and working,
a step of determining to which one of levels the obtained obstacle state belongs, wherein the levels are a first level at which an obstacle is avoided by automatic driving of the mobile body, a second level at which while automatic driving is continued under monitoring by a remote-monitoring person, the remote-monitoring person is made to perform automatic-driving assisting operation, a third level at which driving of the mobile body is performed through remote driving by a monitoring apparatus, and a fourth level at which dispatch of a dispatch worker for performing manual operation is requested, and
a step of making an assist request, when it is determined that the obstacle state belongs to any one of the second level, the third level, and the fourth level.

In the present disclosure, in the case where in the work of conveying and carrying cargos loaded on a cargo-loading vehicle, an obstacle state is detected, the obstacle state is determined and an assist request is made based on a determination level; thus, the load on an assist performing person can be reduced.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a schematic block diagram representing an example of an automatic-driving assisting system according to Embodiment 1;

FIG. 2 is a schematic view of an example of a distribution center, which is a facility for storing conveyed cargos, according to Embodiment 1;

FIG. 3 is a schematic configuration diagram of an obstacle state determination unit in an automatic-driving assisting apparatus according to Embodiment 1;

FIG. 4 is a schematic view of an example of the distribution center, which is a facility for storing conveyed cargos, according to Embodiment 1;

FIG. 5 is a schematic view of an example of the distribution center, which is a facility for storing conveyed goods, according to Embodiment 1;

FIG. 6 is a schematic view of an example of the distribution center, which is a facility for storing conveyed cargos, according to Embodiment 1;

FIG. 7 is a schematic block diagram representing an example of an automatic-driving assisting system according to Embodiment 1;

FIG. 8 is a schematic block diagram representing an example of an automatic-driving assisting system according to Embodiment 1;

FIG. 9 is a flowchart representing a processing routine to be performed by an automatic-driving assisting apparatus according to Embodiment 2;

FIG. 10 is a schematic configuration diagram representing an example of a processing circuit for realizing respective functions of the automatic-driving assisting apparatus according to Embodiment 2;

FIG. 11 is a schematic block diagram representing an example of a mobile body according to Embodiment 3;

FIG. 12 is a flowchart representing an outline flow of processing performed by an automatic-driving assisting system according to Embodiment 3;

FIG. 13 is a schematic block diagram representing an example of a mobile body according to Embodiment 4;

FIG. 14 is a flowchart representing an outline flow of processing performed by an automatic-driving assisting system according to Embodiment 4;

FIG. 15 is a flowchart representing an outline flow of processing performed by an automatic-driving assisting system according to Embodiment 5;

FIG. 16 is a schematic block diagram representing an example of a mobile body according to Embodiment 5;

FIG. 17 is a flowchart representing an outline flow of processing performed by an automatic-driving assisting system according to Embodiment 5;

FIG. 18 is a flowchart representing an outline flow of processing performed by an automatic-driving assisting system according to Embodiment 6;

FIG. 19 is a schematic block diagram representing an example of a mobile body according to Embodiment 6; and

FIG. 20 is a flowchart representing an outline flow of processing performed by an automatic-driving assisting system according to Embodiment 6.

### DETAILED DESCRIPTION OF THE PREFERRED EMBODIMENTS

Embodiments will be explained by use of the drawings. The same or equivalent constituent elements will be designated by the same reference characters, and the detailed explanations therefor will be omitted.

### Embodiment 1

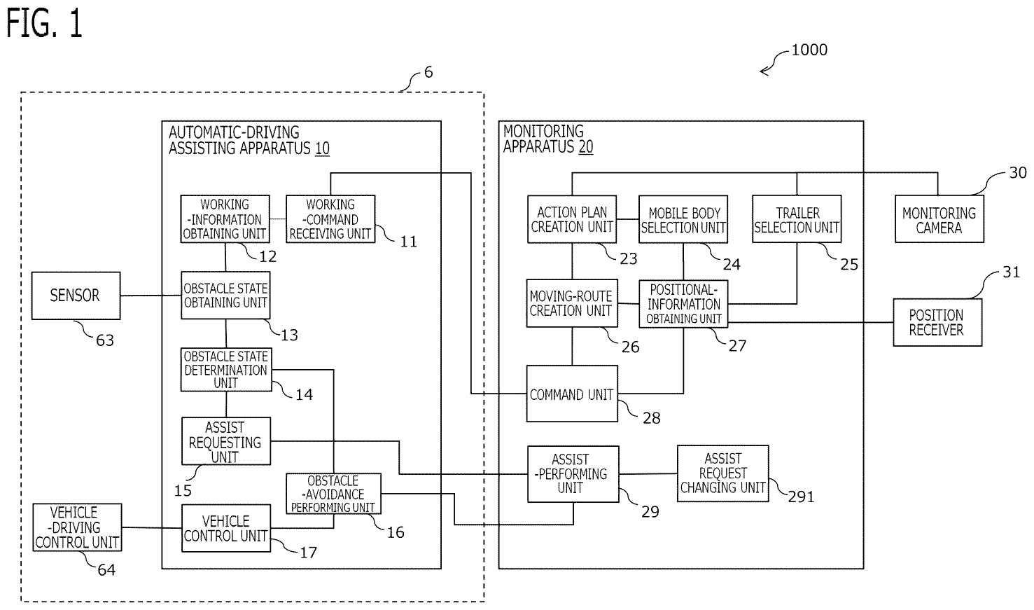

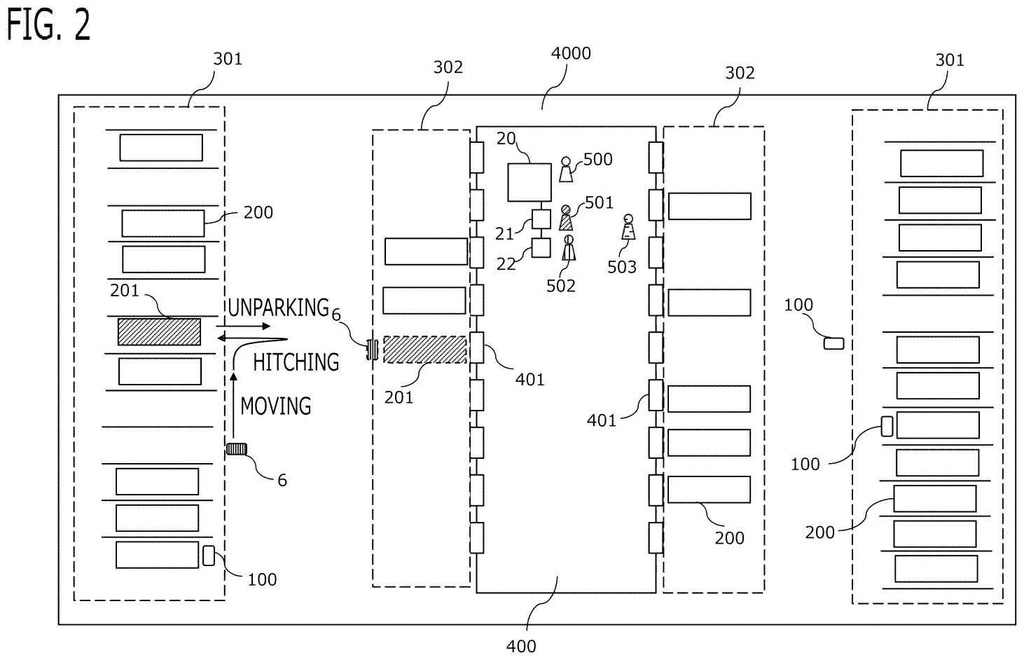

FIG. 1 is a schematic block diagram representing an example of an automatic-driving assisting system 1000 according to Embodiment 1; FIG. 2 is a schematic view of an example of a distribution center 4000, which is a facility for storing conveyed cargos. As illustrated in FIG. 2, the distribution center 4000 is provided with a building 400 having a carry-in port 401 into which goods transported as cargos are carried and a parking place 301 where a trailer 200 loaded with cargos is parked. When arriving at the distribution center 4000 from the outside, the trailer 200 that is towed by the tractor 100 and on which cargos are loaded is parked in the parking place 301. Then, an automatic-driving-feasible mobile body 6 receives a working command for moving to the position of a subject trailer 201 among two or more trailers 200, hitching the subject trailer 201 thereto, towing and unparking the subject trailer 201, making the subject trailer 201 move to a parking place 302 adjoining the carry-in port 401, and then docking the cargo-bed opening of the subject trailer 201 to the carry-in port 401. The mobile body 6 is, for example, an autonomous tractor.

The working command is issued, for example, by a monitoring apparatus 20 in the building 400, and a remote-monitoring person monitors the monitoring apparatus 20. FIG. 2 illustrates an example in which an operator 500 who operates the monitoring apparatus 20, a remote operator 501 who remotely operates the mobile body 6 from a remote operation apparatus 21 in response to an assist request, a remote-driving person 502 who remotely drives the mobile body 6 from a remote-driving apparatus 22 in response to an assist request, and a dispatch worker 503 to be dispatched to the parking places 301 and 302 outside the building 400 in response to an assist request are performing respective works or are on standby. The operator 500, the remote operator 501, remote-driving person 502, and the dispatch worker 503 are remote-monitoring persons. Each of the remote-monitoring persons may play any role. Each of the remote operation apparatus 21 and the remote-driving apparatus 22 is a terminal of the monitoring apparatus 20. It may be allowed that the remote operation apparatus 21 and the remote-driving apparatus 22 are integrated with each other or are separated from each other. It may be allowed that respective different persons take charge of the operator 500, the remote operator 501, the remote-driving person 502, and the dispatch worker 503 or that one person play two or more roles. It may be allowed that several persons share the roles.

In FIG. 1, the monitoring apparatus 20 monitors the trailers 200, the tractors 100, and the like in the parking places 301 and 302, for example, by use of a monitoring camera 30 and obtains the respective positions of the trailers 200 and the mobile bodies 6 by use of the position receiver 31. In the monitoring apparatus 20, for example, a working plan creation unit 23 creates a working plan, a mobile body selection unit 24 selects the mobile body 6 to which a working command is issued, and a trailer selection unit 25 selects the subject trailer 201. Then, a working command including a moving route created by a moving-route creation unit 26 and positional information on the subject trailer 201 that is obtained by a positional-information obtaining unit 27 through the position receiver 31 is transmitted from a command unit 28 to the mobile body 6. A working-command receiving unit 11 of an automatic-driving assisting apparatus 10 provided in the mobile body 6 receives the working command; a working-information obtaining unit 12 obtains positional information items such as the parking position of the subject trailer 201 and the position of a to-be-hitched portion thereof for being towed.

The mobile body 6 performs, for example, a series of operation items described below, in order to make the subject trailer 201 move from the parking place 301 to the parking place 302 adjoining the carry-in port 401.
(a) Based on the obtained moving route, the situation of and information on the peripheral from a sensor 63 such as a camera or a LiDAR (Light Detection And Ranging) are obtained by an obstacle state obtaining unit 13; then, the mobile body 6 moves to the parking place 301 where the subject trailer 201 is parked, while comprehending the obstacle state such as whether or not an obstacle exists.
(b) The sensor 63 detects the subject trailer 201; in the case where the subject trailer 201 is the one to be moved, a hitching route for hitching the mobile body 6 and the subject trailer 201 to each other is created. The hitching route may be the one to be transmitted from the monitoring apparatus 20. In this situation, “hitching” denotes operation for hitching the hitching portion of the mobile body 6 to the to-be-hitched portion of the subject trailer 201; in order to perform this operation, positioning is required. In accordance with the created hitching route, the mobile body 6 is moved at a hitching-feasible angle and then hitching is started. In the case where the hitching fails in the first moving, it may be allowed that the hitching route is created again and the operation is repeated.
(c) After the hitching for hitching the mobile body 6 and the subject trailer 201 to each other has been completed, the mobile body 6 performs unparking for exiting from the parking position while the subject trailer 201 is towed and then returns to the moving route.
(d) The subject trailer 201 is towed to move to the parking place 302 based on the moving route; then, the subject trailer 201 is docked to the carry-in port 401.
(e) The mobile body 6 releases the hitching between the hitching portion thereof and the to-be-hitched portion of the subject trailer 201 and then returns to a standby place.

In some cases, the series of operation items described above include a situation in which the mobile body 6 has a difficulty in continuing automatic-driving operation; for example, the obstacle states below are conceivable.
(1) On the moving route, there exist obstacles 52 and 53 in front of the subject trailer 201.
(2) Because the subject trailer 201 is parked at an unexpected angle, no hitching can be executed.
(3) Because an adjacent trailer 202 is parked adjacent to the subject trailer 201, the subject trailer 201 may make contact with the adjacent trailer 202 during unparking.
(4) Although retry of hitching and docking is performed, the mobile body 6 can move to neither the hitching position nor the docking position.
(5) Hitching between the hitching portion of the mobile body 6 and the to-be-hitched portion of the subject trailer 201 cannot be released.
(6) Due to bad weather, the mobile body 6 cannot be controlled.

Configurations, under these obstacle states, for avoiding the obstacle states will be explained. An obstacle state determination unit 14 provided in the automatic-driving assisting apparatus 10 determines the level of an obstacle state obtained by the obstacle state obtaining unit 13 during moving or working of the mobile body
6. The levels are categorized into the four ones below.
(The first level) An obstacle is avoided by automatic driving of the mobile body 6.
(The second level) While the automatic driving is continued under monitoring by the remote operator 501, the remote operator 501 is made to perform automatic-driving assisting operation.
(The third level) The remote-driving person 502 drives the mobile body 6.
(The fourth level) Dispatch of the dispatch worker 503 for performing manual operation is requested.

The obstacle state determination unit 14 analyzes and calculates which level the obstacle state obtained by the obstacle state obtaining unit 13 is; in the case where the level of the obstacle state is the first level, no assist request is made and the obstacle is avoided by automatic driving of the mobile body 6. In the case where the level of the obstacle state is any one of the second level, the third level, and the fourth level, an assist requesting unit 15 gives notification to an assist-performing unit 29 of the monitoring apparatus 20. Based on the requested level, the monitoring apparatus 20 issues instructions to the remote operator 501, the remote-driving person 502, and the dispatch worker 503 who are remote-monitoring persons.

In the case where the level of the obstacle state is the second level, an obstacle-avoidance performing unit 16 sends information to a vehicle control unit 17, based on auxiliary remote operation, via the remote operator 501, by the assist-performing unit 29. The vehicle control unit 17 makes the mobile body 6 move and work, by sending a command to a vehicle-driving control unit 64 of the mobile body 6.

For example, the assist-performing unit 29 notifies a mobile terminal of the remote operator 501 of information on the subject mobile body 6. Then, the remote operation apparatus 21 is made to display, in real time, information from the sensor 63 provided in the mobile body 6 and an obstacle state obtained from the obstacle state obtaining unit 13 of the automatic-driving assisting apparatus 10; the obstacle is avoided by making the notified remote operator 501 monitor the operation by the mobile body 6, for example, by making him assist the steering-wheel operation through remote operation. After the remote operator 501 confirms that the obstacle has been avoided, the automatic-driving operation of the mobile body 6 is restarted.

In the case where the level of the obstacle state is the third level, the automatic driving by the mobile body 6 is interrupted; the obstacle-avoidance performing unit 16 sends information to the vehicle control unit 17, based on remote driving operation, via the remote-driving person 502, by the assist-performing unit 29. The vehicle control unit 17 makes the mobile body 6 move and work, by sending a command to a vehicle-driving control unit 64 of the mobile body 6.

For example, the assist-performing unit 29 notifies a mobile terminal of the remote-driving person 502 of information on the subject mobile body 6. Then, the remote-driving apparatus 22 is made to display, in real time, information from the sensor 63 provided in the mobile body 6 and an obstacle state obtained from the obstacle state obtaining unit 13 of the automatic-driving assisting apparatus 10; the notified remote-driving person 502 is made to comprehend the situation of the mobile body 6. After that, automatic driving of the mobile body 6 is interrupted; a vehicle driving unit 64 of the mobile body 6 is controlled by making the remote-driving person 502 operate the steering wheel and the accelerator of the remote-driving apparatus 22 while monitoring the video of a vehicle camera, displayed on the remote-driving apparatus 22. After the remote-driving person 502 confirms that the obstacle has been avoided, the automatic driving of the mobile body 6 is restarted.

In the case where the level of the obstacle state is the fourth level, automatic driving of the mobile body 6 is interrupted, and the obstacle state is avoided by manual operation of the dispatched dispatch worker 503.

For example, the assist-performing unit 29 notifies a mobile terminal of the dispatch worker 503 of information on the subject mobile body 6. Then, the notified dispatch worker 503 comprehends the situation of the mobile body 6 through the monitoring apparatus 20, visits the spot, and then avoids the obstacle, for example, by driving the mobile body 6. After it is confirmed that the obstacle has been avoided, the automatic driving of the mobile body 6 is restarted.

It may be allowed that in order to avoid an obstacle, not the vehicle control unit 17 but an unillustrated control unit of the mobile body 6 is utilized. The manual operation by the dispatch worker 503 includes not only driving of the mobile body 6 but also operation of assisting the hitching between the mobile body 6 and the subject trailer 201, operation of inputting the obstacles 52 and 53 or eliminating them by use of another apparatus, and the like.

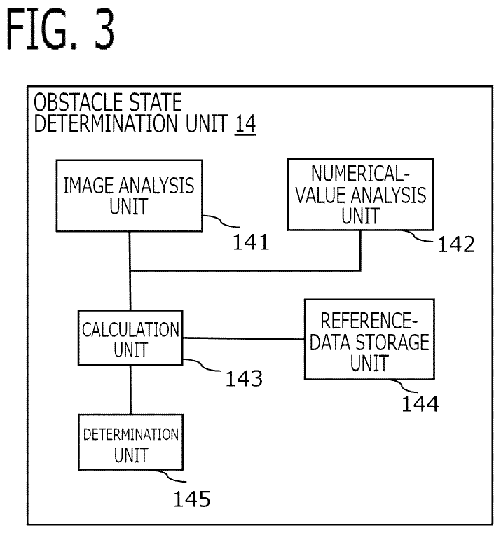

The analysis and calculation regarding which level is an obstacle state is performed by respective processing mechanisms in the obstacle state determination unit 14 represented in FIG. 3. Image data, distance data, and the like obtained by the sensor 63 are analyzed by an image analysis unit 141 and a numerical-value analysis unit 142; a calculation unit 143 compares the foregoing data items with reference data stored in a reference-data storage unit 144; then, a determination unit 145 determines.

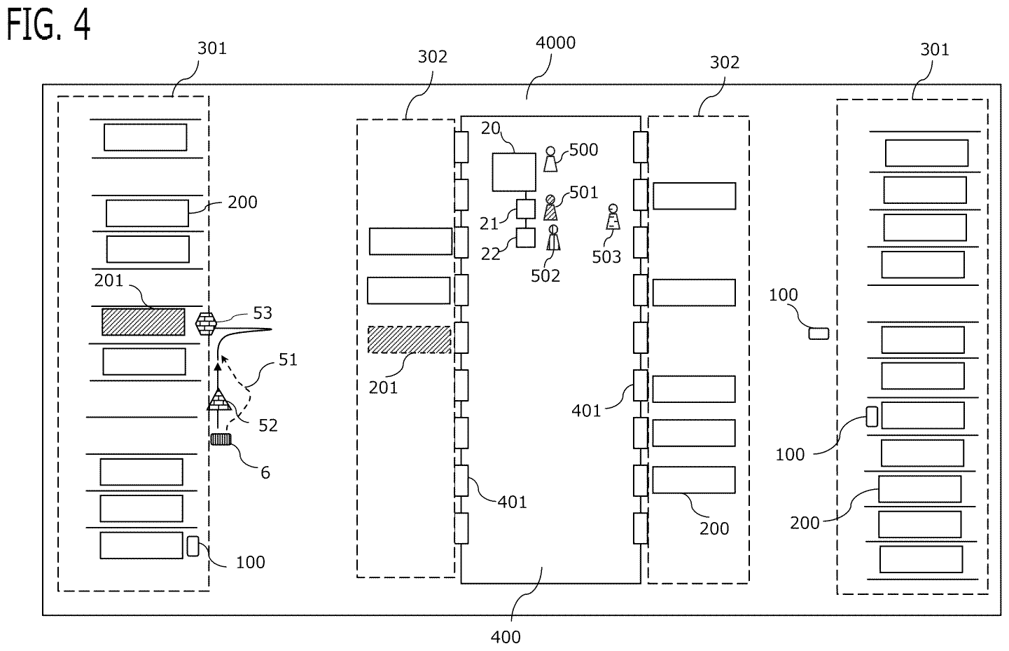

For example, in the case where the obstacle 52 is detected on the moving route of the mobile body 6 illustrated in FIG. 4, the image analysis unit 141 applies image analysis to information from the sensor 63 obtained by the obstacle state obtaining unit 13. In the case where after the image analysis, it is presumed that the obstacle 52 is, for example, a stone, the numerical-value analysis unit 142 performs numerical analysis so as to obtain the magnitude and the like of the stone. In the case where it is understood that when the moving route is changed based on the reference data stored in the reference-data storage unit 144, the obstacle 52 can be avoided, the deviation distance from the moving route acquired, for example, by the working-information obtaining unit 12 is obtained. In the case where the distance is within an allowable range in which it can be corrected by automatic driving of the mobile body 6, it is determined that the level of the obstacle state is the first level. The allowable range may be either preliminarily transmitted from the monitoring apparatus 20 or determined from the reference data. In the case where the deviation exceeds the allowable range, it is determined that the level of the obstacle state is the second level. In the case of the second level, the assist requesting unit 15 requests an assist for remote operation; the remote operator 501 makes the mobile body 6 stand by; the moving-route creation unit 26 partly modifies the moving route so as to create a modified moving route 51; then, the automatic-driving operation of the mobile body 6 is restarted through the remote operation.

In addition, for example, in the case where the obstacle 53 in front of the subject trailer 201 illustrated in FIG. 4 is detected and it is supposed that the result of an image analysis, by the image analysis unit 141, that is applied to information from the sensor 63 obtained by the obstacle state obtaining unit 13 is an animal, it is determined that the level of the obstacle state is the second level. In this case, the remote operator 501 who has received the request for the assist interrupts the automatic driving of the mobile body 6, through remote operation, and then confirms that the animal leaves, by monitoring the sensor 63 through remote operation. When it is confirmed that no dynamic obstacle exists, the automatic driving of the mobile body 6 is restarted through remote operation. In addition, it is determined that the obstacle is a static obstacle, it is determined that the level of the obstacle level is the fourth level. In this case, the dispatch worker 503 who has received an assist request visits the spot and eliminates the obstacle 53 so as to restart the automatic driving of the mobile body 6.

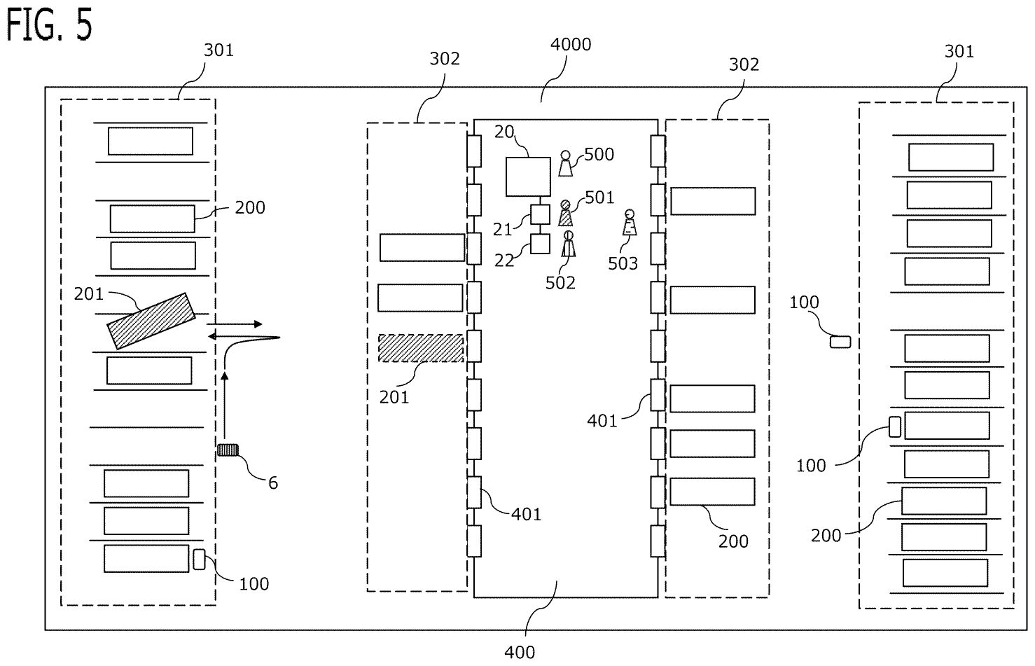

In addition, in the case where it is detected that as illustrated in FIG. 5, the subject trailer 201 is obliquely parked, the level of the obstacle state is determined by use of an angle measured by the sensor 63. When the numerical value obtained through a numerical analysis has a level suggesting that the obstacle can be avoided by automatic driving of the mobile body 6, it is determined that the obstacle state is the first level; when the numerical value has a level suggesting that the obstacle can be avoided by remote operation, it is determined that the obstacle state is the second level; when the numerical value has a level suggesting that the obstacle can be avoided by remote driving, it is determined that the obstacle state is the third level; when the numerical value has a level suggesting that the dispatch worker 503 needs to be dispatched, it is determined that the obstacle state is the fourth level. Then, in the case of the second level, the remote operation is performed; in the case of the third level, the remote driving is performed; in the case of the fourth level, dispatch of the dispatch worker 503 is requested. In the case where these determinations are inadequate, it may be allowed that each of the remote operator 501, the remote-driving person 502, the dispatch worker 503, and the like who have received the respective assist requests changes the assist request by use of an assist request changing unit 291. It may also be allowed that through remote operation, the assist-performing unit 29 makes the obstacle state determination unit 14 operate so as to resume the determination.

The reference data in the obstacle state determination unit 14 may be the one for object-information that can be analyzed by the image analysis unit 141; alternatively, a preliminarily set numerical-value range may be utilized. It may be allowed that past data pieces are stored and then related data is called.

It may be allowed that when a desirable determination can be performed, only any one of the image analysis unit 141 and the numerical-value analysis unit 142 is provided in the obstacle state determination unit 14. It is only necessary that at least one of image data and numerical data is compared with the reference data and then the obstacle state is determined as at least any one of the first, second, third, and fourth levels.

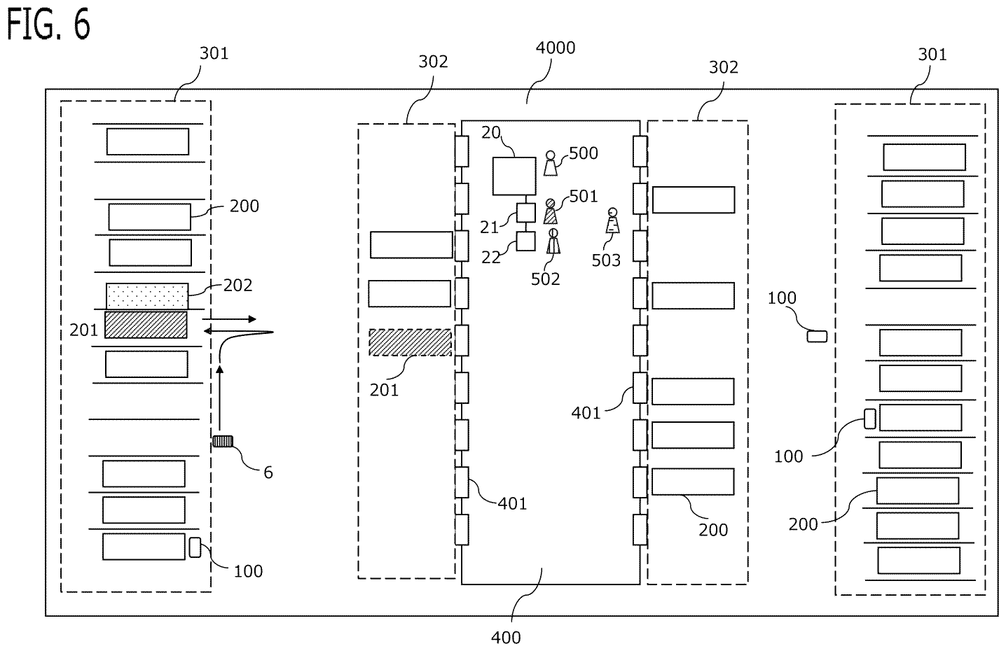

In addition, in the case where as illustrated in FIG. 6, the adjacent trailer 202 is parked adjacent to the subject trailer 201 and there exists a possibility that during unparking, the subject trailer 201 makes contact with the adjacent trailer 202, the distance, represented by a numerical value, between the subject trailer 201 and the adjacent trailer 202 is obtained from the sensor 63 and then the obstacle state is determined in accordance with the magnitude of the numerical value.

In the case where although retry of hitching and docking is performed, the mobile body 6 can move to neither the hitching position nor the docking position, it is conceivable that depending on the number of retries, the obstacle state is determined as the third level and remote driving is requested. When the remote driving cannot be performed, it may be allowed that the obstacle state is determined as the fourth level in the re-determination and then a dispatch request is made.

Moreover, in the case where due to a bad weather such as rain or wind, the mobile body 6 cannot be controlled, it is only necessary to determine the obstacle state as the third or fourth level. It is only necessary to appropriately set the level, based on the respective ground-surface and visibility states of the parking places 301 and 302.

Changing the level may be performed either automatically, by returning to the control by the obstacle state determination unit 14, or performed through remote operation by the remote operator 501 or the remote-driving person 502. It may also be allowed that the dispatch worker 503 or the like changes the level, for example, through button inputting.

As described above, the automatic-driving assisting apparatus 10 includes
the working-information obtaining unit 12 that obtains a target position and a working command,
the obstacle state obtaining unit 13 that obtains an obstacle state hindering automatic-driving operation for at least any one of moving to the target position and working,
the obstacle state determination unit 14 that determines to which one of levels an obstacle state obtained by the obstacle state obtaining unit 13 belongs, wherein the levels are the first level at which an obstacle is avoided by automatic driving of the mobile body 6, the second level at which while the automatic driving is continued under monitoring by the remote-monitoring person, the remote-monitoring person is made to perform automatic-driving assisting operation, the third level at which driving of the mobile body is performed through remote driving, and the fourth level at which dispatch of the dispatch worker for performing manual operation is requested, and
the assist requesting unit 15 that makes an assist request when the obstacle state determination unit 14 determines that the obstacle state belongs to any one of the second level, the third level, and the fourth level; as a result, the assist can be performed in accordance with the level of the obstacle state and hence the load on an assist performing person can be reduced. Moreover, the number of occasions in which the dispatch worker 503 is dispatched to the spot can be minimized.

Moreover, in the case where at least one of the image analysis unit 141 and the numerical-value analysis unit 142 for analyzing image data and numerical data, respectively, is provided and where at least one of the image data and the numerical data is compared with the reference data so that it is determined that the obstacle state belongs to any one of the first level, the second level, the third level, and the fourth level, the levels can be categorized in accordance with the obstacle state.

Moreover, when it is determined to which one of the first level, the second level, the third level, and the fourth level the obstacle state belongs to, by use of two or more threshold values set with regard to obstacle states, the levels can be categorized in accordance with the obstacle state.

Moreover, when the determination is performed in such a way that the degree of an obstacle increases in accordance with the first level, the second level, the third level, and the fourth level in that order, a low-degree obstacle can be coped with without requiring labor or with reduced labor; thus, the load on the assist performing person can be decreased. Moreover, the number of occasions in which the dispatch worker 503 is dispatched to the spot can be minimized.

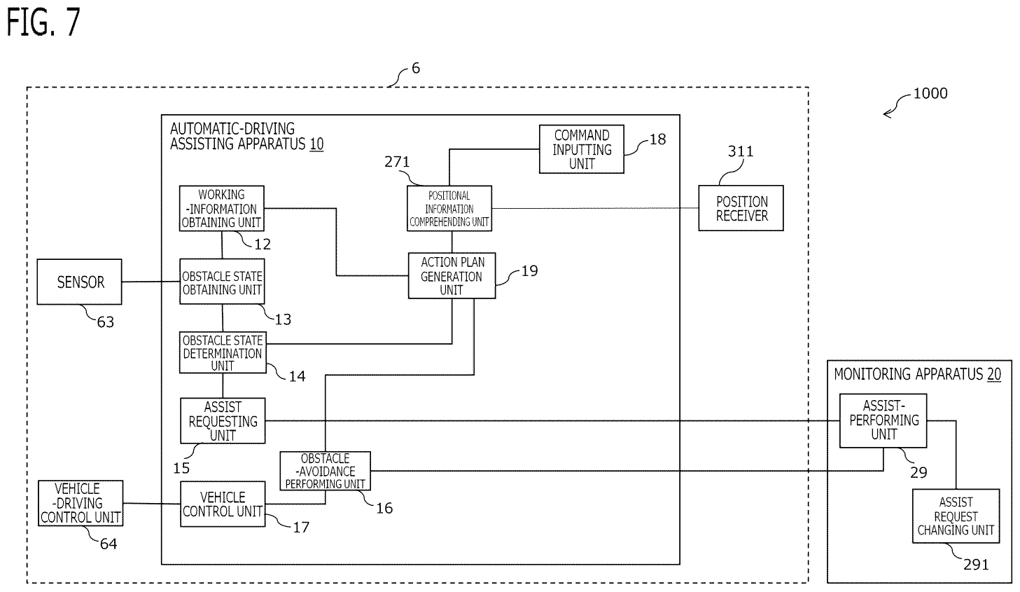

In addition, there has been explained the example in which the positional information of the subject trailer 201 is comprehended through the monitoring apparatus 20, a moving route is created, and the working-command receiving unit 11 receives a command for moving to the target position and for working from the monitoring apparatus 20; however, these processing items may be performed by the mobile body 6. For example, as represented in FIG. 7, in the automatic-driving assisting apparatus 10 mounted in the mobile body 6, based on information on the subject trailer 201 inputted to a command inputting unit 18, a positional-information comprehending unit 271 comprehends the position of the subject trailer 201 through the position receiver 31 of the mobile body 6; based on the contents of work inputted to the command inputting unit 18, an action plan generation unit 19 creates a moving route; then, working-information obtaining unit 12 obtains working information on moving to the target position and the work. Then, an obstacle state that hinders automatic-driving operation for at least any one of the moving to the target position and the work is obtained; it is determined to which one of the first level, the second level, the third level, and the fourth level the level of the obstacle state belongs; then, in the case where it is determined that the obstacle state belongs to any one of the second level, the third level, and the fourth level, an assist request to the monitoring apparatus 20 is made. The assist-performing unit 29 in the monitoring apparatus 20 performs the respective countermeasures. In this situation, as described above, the assist request changing unit 291 in the monitoring apparatus 20 may change the assist requests.

This configuration makes it possible that without any command from the monitoring apparatus 20, the mobile body 6 can perform automatic-driving operation for moving to a target position and working; thus, when an obstacle state is detected, it is made possible that the obstacle state is determined and then an assist can be requested based on the determined level.

In addition, it may be allowed that the action plan generation unit 19 not only generates a moving route but also generates an action plan for avoiding an obstacle, based on an obstacle state obtained by the obstacle state obtaining unit 13. In particular, an obstacle at a time when the obstacle state thereof is determined as the first level can flexibly be avoided.

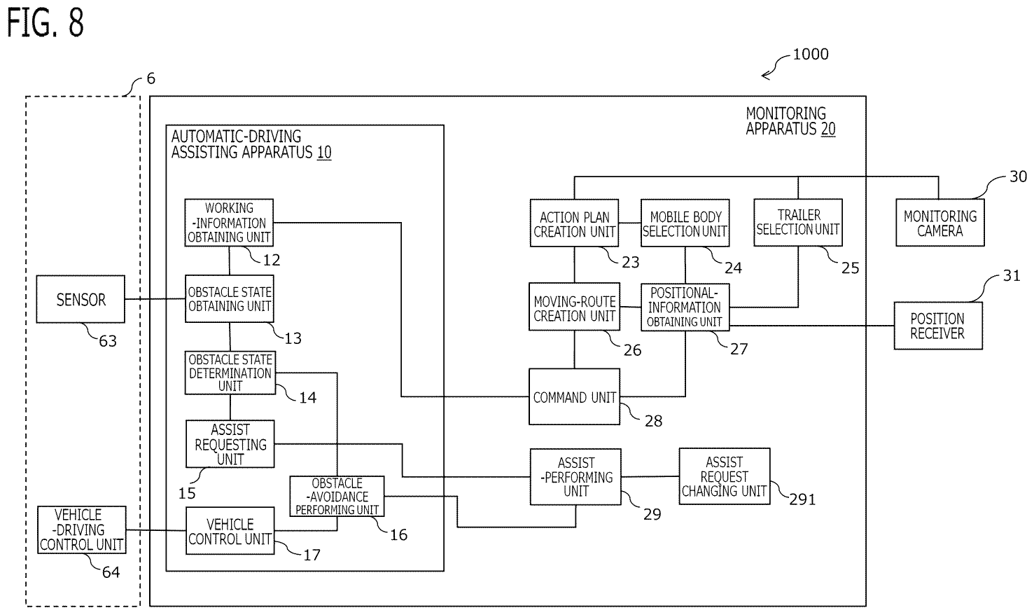

In addition, there has been explained the example in which the automatic-driving assisting apparatus 10 is provided in the mobile body 6; however, it may be allowed that the automatic-driving assisting apparatus 10 is provided outside the mobile body 6 and controls the sensor 63, the vehicle-driving control unit 64, and the like. FIG. 8 represents an example in which the automatic-driving assisting apparatus 10 is provided in the monitoring apparatus 20. Although there has been explained the example in which the monitoring apparatus 20 is provided in the building 400 of the distribution center 4000, it may be allowed that the monitoring apparatus 20 is provided outside the distribution center 4000. The monitoring apparatus 20 may be provided in such a way that the configuration thereof is divided. That is to say, it is only necessary that the monitoring apparatus 20 is configured in such a way as to include the automatic-driving assisting apparatus 10, the positional-information obtaining unit 27 that obtains respective positional information items on a cargo-loading vehicle on which cargos are loaded and a mobile body, the command unit 28 that selects a subject cargo-loading vehicle among two or more cargo-loading vehicles and then issues a command for making the mobile body 6 move to the parking position of the subject cargo-loading vehicle and carry cargos, and the assist-performing unit 29 that responds to assist requests, with regard to an obstacle state hindering automatic-driving operation corresponding to a command, in such a way as to remotely operate the mobile body 6 when an assist for remote operation is requested and to request dispatch of the dispatch worker 503 when manual operation is requested. The respective apparatuses included in the automatic-driving assisting system 1000 are connected with one another through wires or wirelessly and can perform transmission and reception with one another. The same effect can be obtained in each of these embodiments.

### Embodiment 2

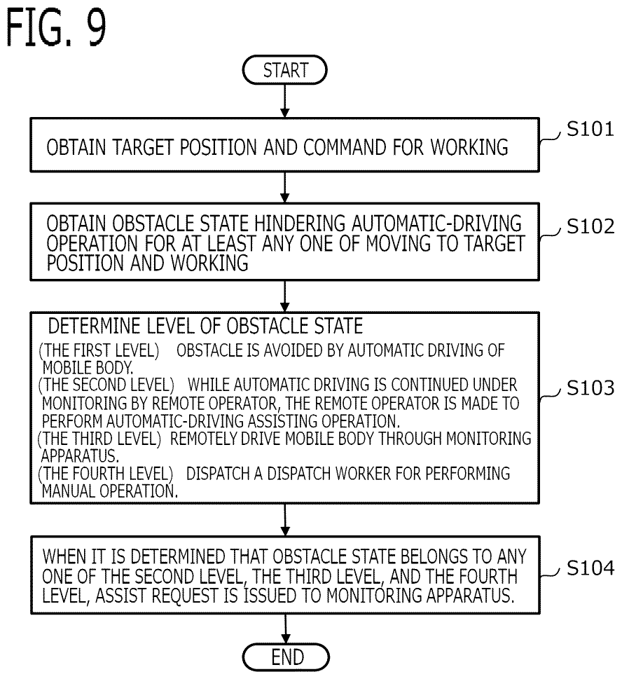

An automatic-driving assisting method utilizing the automatic-driving assisting apparatus 10 will be explained. FIG. 9 is a flowchart representing a processing routine to be performed by the automatic-driving assisting apparatus 10 according to Embodiment 2.

At first, a target position and a working command are obtained from the command unit 28 of the monitoring apparatus 20 or the command inputting unit 18 of the automatic-driving assisting apparatus 10 (the step S101). Then, an obstacle state hindering automatic-driving operation for at least any one of moving to the target position and working is obtained (the step S102). Next, the level of the obstacle state is determined as the first level at which an obstacle is avoided by automatic driving of the mobile body 6, the second level at which while the automatic driving is continued under monitoring by a remote-monitoring person, the remote-monitoring person is made to perform automatic-driving assisting operation, the third level at which remote driving of the mobile body 6 is performed through the monitoring apparatus 20, or the fourth level at which dispatch of the dispatch worker 503 for performing manual operation is requested (the step S103). After that, when it is determined that the obstacle state belongs to any one of the second level, the third level, and the fourth level, an assist request is issued to the monitoring apparatus 20 (the step S104). The automatic-driving assist can be achieved by repeating these steps.

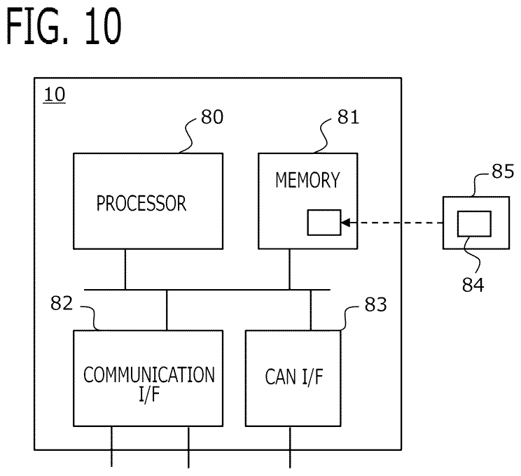

The respective functions of the automatic-driving assisting apparatus 10 are realized by a processing circuit. FIG. 10 is a schematic configuration diagram representing an example of a processing circuit for realizing respective functions of the automatic-driving assisting apparatus 10. The automatic-driving assisting apparatus 10 has a processor 80, a memory 81, a communication I/F (interface) 82, a CAN (Control Area Network) I/F (interface) 83, and the like. As the processor 80, for example, a CPU (Central Processing Unit) is utilized. The memory 81 transmits data to and receives data from the processor 80 and stores data. Data to be measured by the sensor 63 is obtained through the communication I/F 82. The respective processing items performed by the working-command receiving unit 11, the working-information obtaining unit 12, the obstacle state obtaining unit 13, the obstacle state determination unit 14, the image analysis unit 141, the numerical-value analysis unit 142, the calculation unit 143, the determination unit 145, the assist requesting unit 15, the obstacle-avoidance performing unit 16, the vehicle control unit 17, and the like are performed by the processor 80. Reference data, a calculation equation, and the line are stored in the memory 81. A command of the automatic-driving assisting apparatus 10 is transmitted to the vehicle-driving control unit 64 through the CAN I/F 83.

The processor 80 and the memory 81 may be either integrated with each other or separated from each other. The processor 80 may be provided with logic circuits and various kinds of signal processing circuits each utilizing, for example, an ASIC (Application Specific Integrated Circuit), an IC (Integrated Circuit), a DSP (Digital Signal Processor), an FPGA (Field Programmable Gate Array), or the like. It may be allowed that as the processor 80, two or more computing processing units of the same type or different types are provided and respective processing items are implemented by the two or more computing processing units in a sharing manner.

As the two or more memories 81, there are provided, for example, a RAM (Random Access Memory) that can read data from and write data in the processor 80, a ROM (Read Only Memory) that can read data from the processor 80, a hard disk, and the like.

The processor 80 executes software or a program stored in the memory 81 and collaborates with hardware, so that the respective functions of the automatic-driving assisting apparatus 10 are realized. Setting data to be set in the automatic-driving assisting apparatus 10 may be either stored, as part of software or a program, in the memory 81 or inputted by a user. It may be allowed that a non-temporary memory medium 85 in which an information processing program 84 is distributed and installed in the automatic-driving assisting apparatus 10 (the memory 81).

As described above, a target position and a working command are received; an obstacle state hindering automatic-driving operation for any one of moving to the target position and the work is obtained; the level of the obstacle state is determined as the first level at which an obstacle is avoided by automatic driving of the mobile body 6, the second level at which while the automatic driving is continued under monitoring by a remote-monitoring person, the remote-monitoring person is made to perform automatic-driving assisting operation, the third level at which remote driving of the mobile body 6 is performed through the monitoring apparatus 20, or the fourth level at which dispatch of the dispatch worker 503 for performing manual operation is requested; when it is determined that the obstacle state belongs to any one of the second level, the third level, and the fourth level, an assist request is issued to the monitoring apparatus 20. Thus, the assist can be performed in accordance with the level of the obstacle state and hence the load on an assist performing person can be reduced. Moreover, the number of occasions in which the dispatch worker 503 is dispatched to the spot can be minimized.

### Embodiment 3

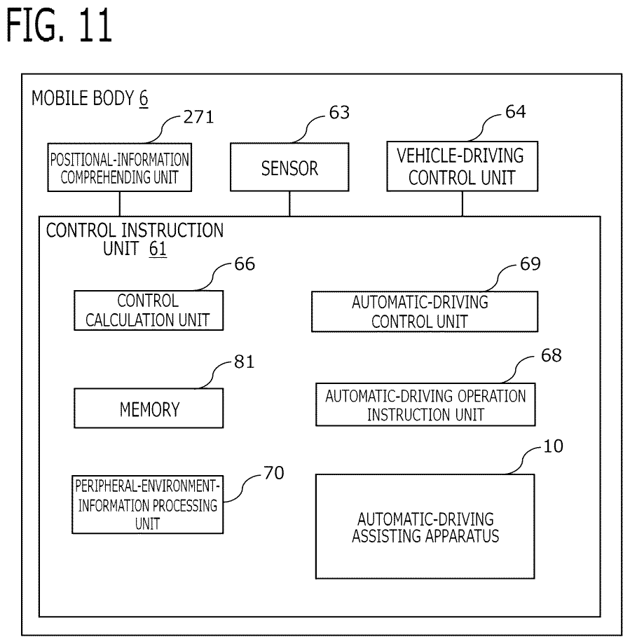

In Embodiment 3, an example of the mobile body 6 in which the automatic-driving assisting apparatus 10 is mounted will be explained. FIG. 11 is a block diagram representing the example of the mobile body 6 according to Embodiment 3. The mobile body 6 is provided with a control instruction unit 61 that issues a control instruction for automatic-driving operation. The control instruction unit 61 is an integrated body of ECUs (Electronic Control Units) to be mounted in the mobile body 6. In addition, the mobile body 6 has the positional-information comprehending unit 271 for comprehending a positional information, the sensor 63 for obtaining peripheral information, and the vehicle-driving control unit 64 for controlling driving and steering. These units are connected with the control instruction unit 61 by use of a CAN (Controller Area Network), a UDP (User Datagram Protocol), or the like.

The control instruction unit 61 has a control calculation unit 66 that performs processing of peripheral information and calculation processing in response to a control command and the memory 81 that stores data and the like. The control instruction unit 61 also has an automatic-driving operation instruction unit 68 that instructs desired automatic-driving operation and an automatic-driving control unit 69 that controls a mobile body so as to realize operation for which instruction has been given by the automatic-driving operation instruction unit 68. The instruction of the automatic-driving operation instruction unit 68 may be either the one for making the mobile body 6 to a specific point or the one for specific operation such as hitching or docking. The sensor 63 is a camera, a LiDAR apparatus, or the like for obtaining information items on peripheral buildings, roads, obstacles, and the like; the obtained information items are processed by a peripheral-environment-information processing unit 70.

Moreover, the control instruction unit 61 has an automatic-driving assisting apparatus 10 that solves a difficult situation where it is difficult to continue the foregoing automatic-driving operation. In this example, the control signal of the vehicle control unit 17 explained in Embodiment 1 is sent to the automatic-driving operation instruction unit 68 and then is transmitted to the vehicle-driving control unit 64 by way of the automatic-driving control unit 69. In addition, the obstacle state obtaining unit 13 obtains part of data processed by the peripheral-environment-information processing unit 70, determines the level of an obstacle state, and then issues an assist request. The respective functions of the control calculation unit 66, the memory 81, the automatic-driving operation instruction unit 68, the automatic-driving control unit 69, and the peripheral-environment-information processing unit 70 may be utilized in the control and the processing performed in the automatic-driving assisting apparatus 10.

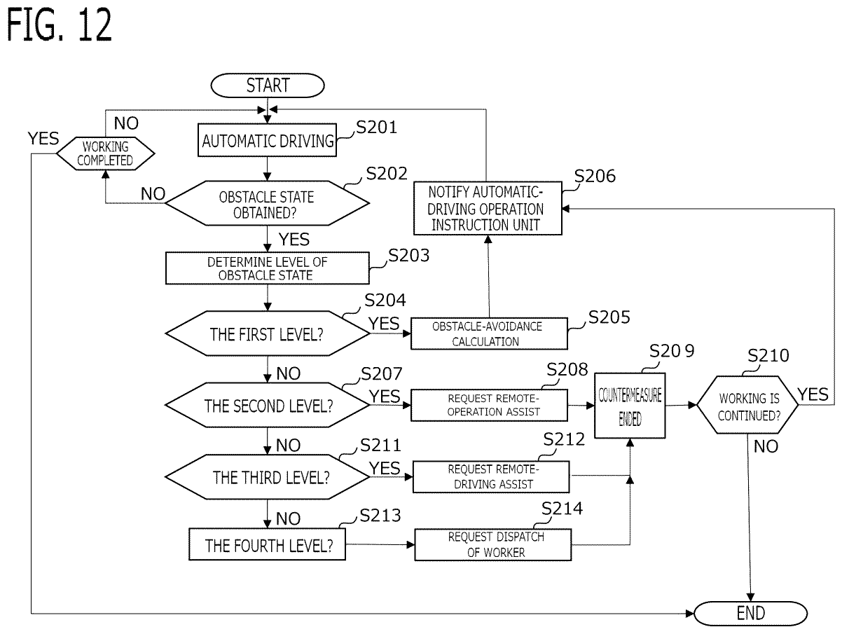

FIG. 12 is a flowchart representing an outline flow of processing performed by the automatic-driving assisting system 1000. When the automatic-driving operation instruction unit 68 gives the automatic-driving control unit 69 an instruction for automatic-driving operation, automatic driving of the mobile body 6 is started of continued (the step S201). Also when the automatic-driving control unit 69 receives a working command form the monitoring apparatus 20, the flow starts with this operation. Then, the obstacle state obtaining unit 13 obtains part of data processed by the peripheral-environment-information processing unit 70 (the step S202) and determines the level of an obstacle state (the step S203). Next, it is determined whether or not the level of the obstacle state is the first level (the step S204); when the level of the obstacle state is the first level (YES in the step S204), a calculation for avoiding the obstacle is performed (the step S205); then, based on the calculation result, an instruction related to driving operation is notified to the automatic-driving operation instruction unit 68 (the step S206). The automatic-driving operation instruction unit 68 transmits the notified information to the automatic-driving control unit 69 and then returns to the step S201 where the automatic-driving operation is continued.

In the case where the level of the obstacle state is not the first level (NO in the step S204), it is determined whether or not the level of the obstacle state is the second level (the step S207). In the case where the level of the obstacle state is the second level (YES in the step S207), a remote operation assist is issued to the monitoring apparatus 20 (the step S208); then, while the automatic driving is continued under monitoring by a remote-monitoring person, the remote-monitoring person is made to perform automatic-driving assisting operation until the obstacle state is coped with (the step S209). After the assist-performing unit 29 copes with the obstacle state, it is determined whether or not the work is continued; in the case where the work is continued (YES in the step S210), the determination is notified to the automatic-driving operation instruction unit 68 (the step S206); then, the automatic-driving operation is resumed (the step S201). In the case where the work is not continued (NO in the step S210), the automatic-driving operation is ended.

In the case where the level of the obstacle state is not the second level (NO in the step S207), it is determined whether or not the level of the obstacle state is the third level (the step S211). In the case where the level of the obstacle state is the third level (YES in the step S211), a request for the remote-driving assist is issued to the monitoring apparatus 20 (the step S212); then, until the obstacle state is coped with, moving and working is performed through remote driving. After the assist-performing unit 29 copes with the obstacle state, it is determined whether or not the work is continued; in the case where the work is continued (YES in the step S210), the determination is notified to the automatic-driving operation instruction unit 68 (the step S206); then, the automatic-driving operation is resumed (the step S201). In the case where the work is not continued (NO in the step S210), the automatic-driving operation is ended.

In the case where the level of the obstacle state is not the third level (NO in the step S211), it is determined that the level of the obstacle state is the fourth level (the step S213); then, a request for dispatching a worker is issued to the monitoring apparatus 20 (the step S214). After the dispatch worker copes with the obstacle state, it is determined whether or not the work is continued; in the case where the work is continued (YES in the step S210), the determination is notified to the automatic-driving operation instruction unit 68 (the step S206); then, the automatic-driving operation is resumed (the step S201). In the case where the work is not continued (NO in the step S210), the automatic-driving operation is ended.

As described above, in the case where it is determined in the step S204 that the level of the obstacle state is the first level, the automatic-driving operation is continued; thus, the load on the assist performing person can be reduced. In the case where it is determined in the step S207 that the level of the obstacle state is the second level, the automatic-driving operation is continued and the remote operator 501 makes a determination on part of automatic-driving operation items, while basic and specific operation items are left to automatic driving of the automatic-driving vehicle; therefore, the working load on the remote operator 501 is reduced. In the case where it is determined in the step S211 that the level of the obstacle state is the third level, the automatic-driving operation is interrupted and all or part of the specific operation items are left to remote driving through remote control. Because the remote-driving person 502 does not need to visit the spot, his working load is reduced. In the case where it is determined in the step S213 that the level of the obstacle state is the fourth level, dispatch of a person to the spot makes it possible to escape from a difficult situation. Although a worker who visits the spot is required, the assist can be performed in accordance with the level of the obstacle state and hence the load on an assist performing person can be reduced. Moreover, the number of occasions in which the dispatch worker 503 is dispatched to the spot can be minimized.

In addition, it may be allowed that the determination on the level of an obstacle state in each of the steps S203, S204, S207, S211, and S213 is performed with respect to an automatic-driving-feasible boundary defined in a designing manner by an ODD (Operational Design Domain) definition with which the automatic-driving assisting system 1000 defines an operable area. Moreover, for example, when the boundary is defined in a system designing, with regard to whether or not automatic driving can be continued under remote monitoring by the monitoring apparatus 20, the reference for remote operation is obtained. As each of these references, there may be utilized the one set by presuming from quantitative statistic data such as variance or a standard value related to the control of automatic driving; alternatively, the reference may be set by a fixed value obtained from the reference that has empirically been confirmed. By use of each of these references, it is determined whether or not automatic driving, remote operation, remote driving, or manual operation by a dispatch worker is performed. In order to reduce the load on the assist performing person and to raise the availability factor of the facility distribution, higher priority is given to not remote operation but automatic driving of the mobile body 6 and higher priority is given to not remote driving but remote operation. In the case where none of these assists makes it possible to escape from a difficult situation, an assist of dispatching the dispatch worker 503 to the spot is performed. It may be allowed that the ODD includes not only the external contributing factors such as a traveling-environment condition and a road condition but also an inner-system environmental condition such as a failure in the system communication. In the case where there exists no preliminarily designed ODD reference, it may be allowed to utilize a determination selected by the assist performing person.

Moreover, in the case where there exist assist requests for the respective levels in the steps S207, S211, and S213, each of the assist performing persons may change the level. For example, in the case where the remote operator 501 determines that it is difficult to solve an obstacle state through remote operation or remote driving, it may be allowed that the level is changed to the fourth level and then an assist of dispatching the dispatch worker 503 to the spot is performed. Moreover, it may be allowed that in order to solve an obstacle state, dispatching another mobile body is selected. In this case, it may be allowed either that the level is changed to the second level and the remote operator 501 performs the operation of making the mobile body 6 leave and sending another mobile body or that the level is changed to the fourth level and the dispatch worker 503 performs the operation of making the mobile body 6 leave and sending another mobile body. Moreover, it is made possible that in consideration of the availability factor of the distribution center 4000, the business volume, or the respective availability factors of two or more mobile bodies 6, the levels are changed.

As described above, involvement of persons can be reduced by flexibly coping with the work of conveying and carrying goods loaded on cargo-loading vehicles.

### Embodiment 4

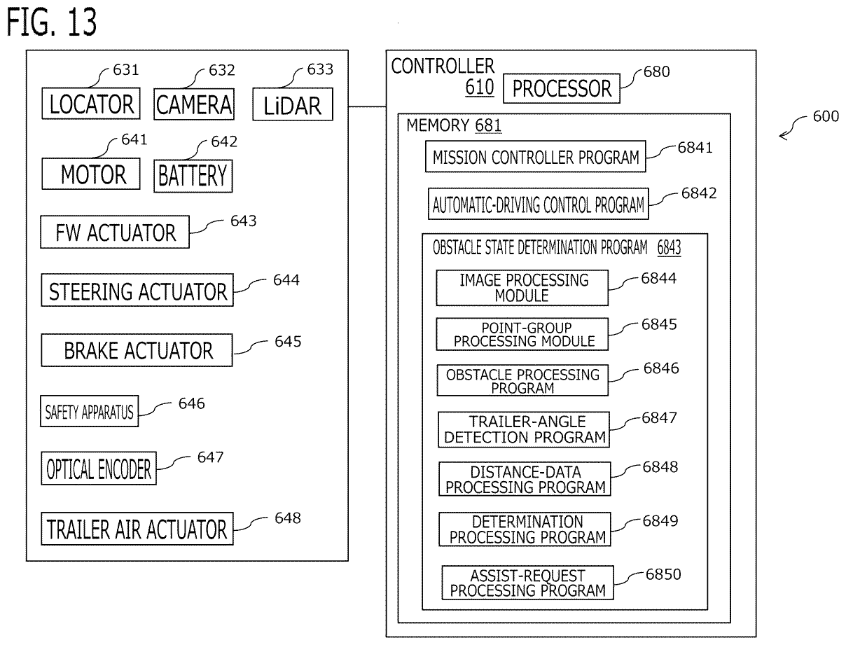

In Embodiment 4, an example of the mobile body 600 in which the automatic-driving assisting apparatus 10 is mounted will be explained. FIG. 13 is a schematic block diagram representing an example of the mobile body 600 according to Embodiment 4. In the present embodiment, the mobile body 600 is, for example, an autonomous tractor. In FIG. 13, the mobile body 600 has a locator 631 for specifying a position, a camera 632 and a LiDAR 633 for obtaining peripheral-object information and the like, a motor 641 for driving the mobile body 600, a battery 642, a FW (Forward) actuator 643 for preforming automatic driving and steering, a steering actuator 644, a brake actuator 645, a safety apparatus 646, an optical encoder 647 for measuring a rotational displacement, a trailer air actuator 648 for adjusting the height of the trailer 200, and the like. These apparatuses are connected with a controller 610 through a CAN I/F 83, a UPD, or the like. The controller 610 performs a control instruction for automatic-driving operation. The controller 610 is an integrated body of ECUs to be mounted in the mobile body 600.

The controller 610 has one or more processors 680 and one or more memories 681 connected with the one or more processors 680. The processor 680 executes programs so as to realize respective processing items. The programs are stored in the memory 681; there are prepared a mission controller program 6841 for controlling and calculating a command, an automatic-driving control program 6842 for controlling the mobile body 600 so as to realize automatic-driving operation instructed by the mission controller program 6841, an obstacle state determination program 6843 for determining the level of an obstacle state, and the like. The obstacle state determination program 6843 includes an image processing module 6844 for processing image data of the camera 632, obtained by the obstacle state obtaining unit 13, a point-group processing module 6845 for analyzing a point group measured by the LiDAR 633, and the like. Moreover, the obstacle state determination program 6843 includes an obstacle processing program 6846 for processing information items on the obstacles 52 and 53, a trailer-angle detection program 6847 for detecting a parking angle of the subject trailer 201, a distance-data processing program 6848 for processing distance data items such as a distance between the subject trailer 201 and the adjacent trailer 202 and a distance of contact, a determination processing program 6849 for performing determination processing, an assist-request processing program 6850, and the like.

The mission controller program 6841 instructs the automatic-driving control program 6842 of operation items such as hitching and docking. Image data and numerical data analyzed by the image processing module 6844 and the point-group processing module 6845 are utilized for determining the level of an obstacle state. The obstacle processing program 6846 is utilized for performing processing, when as an obstacle state, the obstacle 52 or 53 is detected in a moving route or in front of the subject trailer 201. When the subject trailer 201 is parked at an unexpected angle and hence hitching cannot be performed, the trailer-angle detection program 6847 is utilized in processing for determining the level of the obstacle state in accordance with the magnitude of the angle. When the adjacent trailer 202 is parked adjacent to the subject trailer 201 and hence there exists a possibility that the subject trailer 201 makes contact with the adjacent trailer 202 in moving in a hitching route or unparking, the distance-data processing program 6848 is utilized in processing for determining the level of the obstacle state in accordance with the magnitude of the distance. The determination processing program 6849 is utilized for determining the level of an obstacle state; the assist-request processing program 6850 issues an assist request to an assist performing person, in accordance with the determined level of the obstacle state.

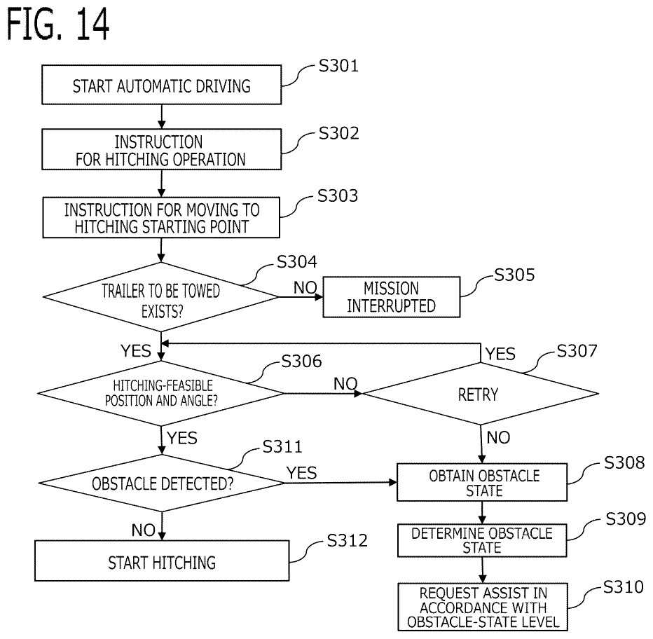

The automatic-driving control program 6842 also includes a module for processing peripheral-environment information by use of the camera 632, the LiDAR 633, and the like; thus, a program for confirming whether or not automatic-driving operation can be started is provided. FIG. 14 is a flowchart representing an example of part of processing, for example, in executing hitching operation, performed by the automatic-driving assisting system 1000 through the mission controller program 6841. An operational instruction is issued, while whether or not the subject trailer 201 is parked at an unexpected angle and whether or not the obstacle 53 exists are ascertained.

At first, after confirming that automatic driving can be started, the automatic driving is started (the step S301). When the mobile body 600 is the automatic driving mode, a hitching-operation instruction is inputted to the mission controller program 6841 (the step S302). Then, the mission controller program 6841 instructs the mobile body 600 to move to a hitching-feasible point (the step S303). Next, by use of the camera 632, the LiDAR 633, and the like, it is ascertained whether or not at the point to which the mobile body 600 has moved, there exists the subject trailer 201 to be towed (the step S304). In the case where the subject trailer 201 does not exist (NO in the step S304), the execution of hitching operation is interrupted (the step S305). In the case where it is confirmed that the subject trailer 201 exists (YES in the step S304), the automatic-driving control program 6842 generates a route in which alignment required to hitch the hitching portion of the mobile body 600 to the to-be-hitched portion of the subject trailer 201 is performed. In order to ascertain whether or not the position and the angle to be required at the end of the generated route are satisfied, the angle is obtained by use of the image processing module 6844 based on the camera 632, the point-group processing module 6845 based on the LiDAR 633, and the trailer-angle detection program 6847.

In the case where the hitching-feasible position and angle with which the mobile body 600 can perform hitching are not satisfied (NO in the step S306), the route is modified so as to perform retrying (YES in the step S307). In the case where even when the retrying is performed a specified number of times, the hitching-feasible position and angle are not satisfied, the retrying is interrupted (NO in the step S307), the obstacle state is obtained (the step S308), the obstacle state is determined (the step S309), and then an assist request is instructed in accordance with the level of the obstacle state (the step S310). In the case where the hitching-feasible position and angle are satisfied, i.e., the angle between the parking direction of the subject trailer 201 and the appropriate parking line is smaller than a first threshold value (YES in the step S306), the step S306 is followed by the next step S311.

In this situation, it is only necessary to set the first threshold value in such a way, for example, that in the case where the angle between the parking direction of the subject trailer 201 and the appropriate parking line is defined as 0° when the foregoing parking direction and the appropriate parking line coincide with each other, hitching is feasible when the measured angle is smaller than 2°. In addition, the second threshold value, the third threshold level, and the fourth threshold level are set to 3°, 10°, and 15°, respectively; when the foregoing angle is the same as or larger than 2° but smaller than 3°, the obstacle state is set to the first level at which the obstacle can be avoided by automatic driving of the mobile body 600; when the foregoing angle is the same as or larger than 3° but smaller than 10°, the obstacle state is set to the second level at which while the automatic driving is continued under monitoring by a remote-monitoring person, the remote-monitoring person is made to perform automatic-driving assisting operation. The mobile body 600 performs basic actions such as cognition, determination, and operation required in driving, and the remote operator 501, for example, makes the mobile body 600 operate at low speed so as to perform an assist for modifying the orbit in such a way that the respective angles of the mobile body 600 and the subject trailer 201 coincide with each other. For example, when the foregoing angle is the same as or larger than 10° but smaller than 15°, the obstacle state is set to the third level at which the monitoring apparatus 20 performs remote driving of the mobile body 600. It is not required that the remote-driving person 502 performs all the actions such as cognition, determination, and operation required in driving; it may be allowed that only part of the functions are performed by the remote-driving person 502 and the other functions are assisted by the functions of the mobile body 600. When the foregoing angle is the same as or larger than 15°, the obstacle state is set to the fourth level at which dispatch of the dispatch worker 503 for performing manual operation is requested.

The foregoing angles are examples; the threshold values may be set or changed based on past data items and the like. In the case where the angle is utilized as the reference and, for example, there exists no angle corresponding to the first level, it is only necessary to skip the step of avoiding the obstacle through automatic driving. When there exists no angle corresponding to the second level, the assist request may be set to the third or higher level. It may be allowed that not all the threshold values from the first level to the fourth level are set but only some certain threshold values are set.

In addition, when the automatic-driving operation becomes able to be restarted after the assist has been performed, either the automatic-driving operation may be restarted from the middle of operation or the remote operator 501 may take over being in charge from the remote-driving person 502. Moreover, the assist request of the third level at which remote driving is requested may be changed to the one for which an assist performing person dispatches the dispatch worker 503 to the spot.

In the case where the mobile body 600 can be made to move to a hitching-feasible position where a hitching-feasible angle is satisfied (YES in the step S306), the step S306 is followed by the step S311, where an obstacle is detected. In the case where an obstacle is detected (YES in the step S311), the obstacle state is obtained (the step S308), the obstacle state is determined (the step S309), and then an assist request is instructed in accordance with the level of the obstacle state (the step S310). In the case where no obstacle is detected (NO in the step S311), hitching is started when no other obstacle exists (the step S312). The example of performing assisting at a time when an obstacle is detected, is the same as that in Embodiment 1; therefore, the explanation therefor will be omitted.

In the case where performing assisting make it possible to restart the automatic-driving operation, the fact that the automatic-driving operation can be restarted is notified to the mission controller program 6841. In the case where performing assisting cannot complete the work, the fact that the work cannot be completed and hence the automatic-driving operation cannot be restarted is notified to the mission controller program 6841.

As described above, it is ascertained whether or not the condition is the one under which the automatic-driving operation instructed by the mission controller program 6841 can be started; then, in the case where all the conditions are satisfied, the instructed work is started. In the case where all the conditions are not satisfied, that is to say, in the case where an obstacle state hindering automatic-driving operation for at least any one of moving to the target position and working is obtained, the level of the obstacle state is determined as the first level at which an obstacle is avoided by automatic driving of the mobile body 600, the second level at which while the automatic driving is continued under monitoring by a remote-monitoring person, the remote-monitoring person is made to perform automatic-driving assisting operation, the third level at which remote driving of the mobile body 600 is performed through the monitoring apparatus 20, or the fourth level at which dispatch of a dispatch worker for performing manual operation is requested; when it is determined that the obstacle state belongs to any one of the second level, the third level, and the fourth level, an assist request is issued to the monitoring apparatus 20. Thus, the assist can be performed in accordance with the level of the obstacle state and hence the load on an assist performing person can be reduced. Moreover, the number of occasions in which the dispatch worker 503 is dispatched to the spot can be minimized.

### Embodiment 5

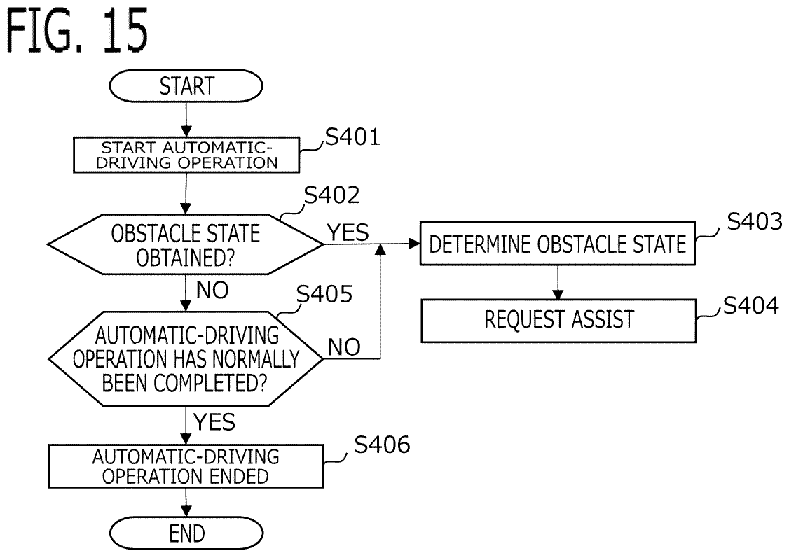

In Embodiment 5, there will be explained an example in which in the case where objective automatic-driving operation is not normally completed, it is determined that the automatic-driving operation cannot be continued and then an assist is requested. FIG. 15 is a flowchart representing an outline flow of processing performed by the automatic-driving assisting system 1000 according to Embodiment 5. The flow—automatic-driving operation of the mobile body 600 is started (the step S401); in the case where an obstacle state is obtained (YES in the step S402), the obstacle state is determined (the step S403), and then an assist is requested (the step S404)—is the same as that in each of Embodiments 1 through 3. Embodiment 5 is different from each of Embodiments 1 through 3 in that it is ascertained whether or not objective automatic-driving operation has normally been completed (the step S405). In the case where the objective automatic-driving operation has not normally been completed (NO in the step S405), the obstacle state is determined (the step S403) and then an assist is requested (the step S404).

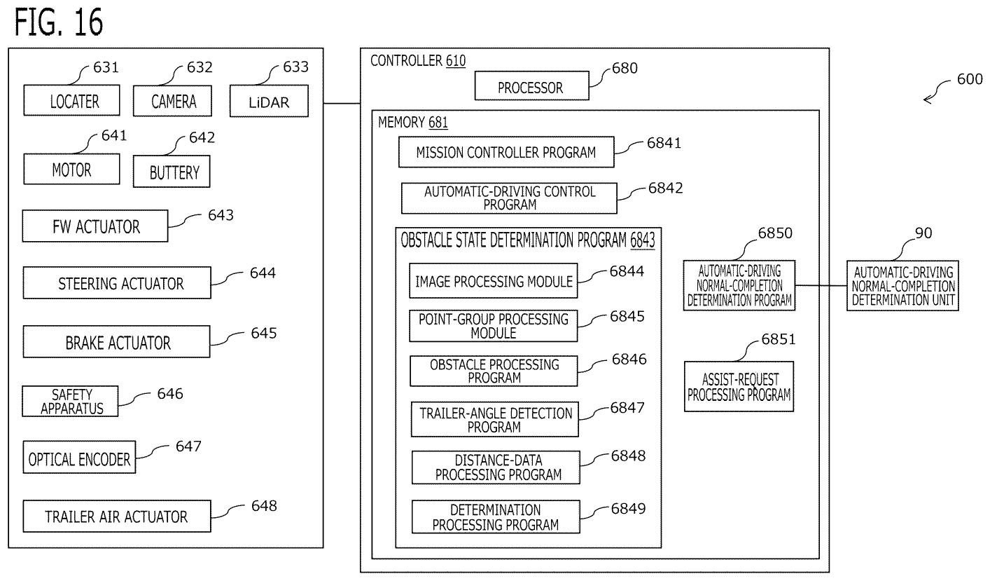

FIG. 16 is a schematic block diagram representing an example of the mobile body 600 according to Embodiment 5. In the present embodiment, the mobile body 600 is, for example, an autonomous tractor. As is the case with Embodiment 4, the mobile body 600 has the locator 631 for specifying a position, the camera 632 and the LiDAR 633 for obtaining peripheral-object information and the like, the motor 641 for driving the mobile body 600, and the controller 610 for instructing the control of respective mechanisms such as the battery 642 and the like and automatic-driving operation. The controller 610 has the processor 680 and the memory 681; the processor 680 executes programs stored in the memory 681. The memory 681 is provided with an automatic-driving normal-completion determination program 6850 for determining whether or not desired automatic-driving operation has normally been completed, in addition to the configuration of Embodiment 4. The case where the operation is not normally completed denotes, for example, a case where because in hitching operation, the mobile body 600 has been controlled along a generated route and then angle alignment and positioning have apparently been completed at a point displaced from the route, the respective heights of the hitching portion of the mobile body 600 and the to-be-hitched portion of the subject trailer 201 do not coincide with each other even though the angle alignment and the positioning have normally been completed. An automatic-driving normal-completion determination unit 90 for executing the automatic-driving normal-completion determination program 6850, for example, ascertains whether or not desired operation has been completed; in the case where the desired operation has not been completed, the automatic-driving normal-completion determination unit 90 obtains an obstacle state, determines the obstacle state, and then requests an assist in accordance with the level of the obstacle state.

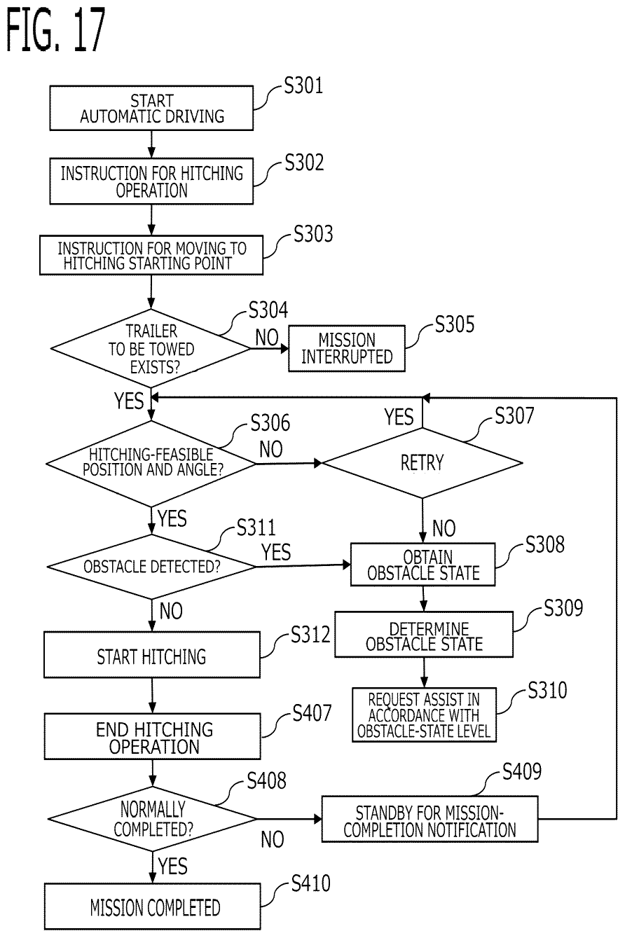

FIG. 17 is a flowchart representing an example of part of processing, for example, in executing hitching operation, performed by the automatic-driving assisting system 1000 through the mission controller program 6841. The steps S301 through S312 where hitching is started advance in a manner the same as that in Embodiment 4; thus, the explanation therefor will be omitted. When instructed hitching operation ends (the step S407), it is ascertained whether or not the hitching has normally been completed; in the case where the desired operation has not been completed (NO in the step S408), a mission-completion notification is made to stand by (the step S409); then, for example, the step 409 is followed by the step S306 where it is ascertained whether or not the hitching-feasible position and angle are satisfied. It may be allowed that the level of an obstacle state where the hitching has not normally been completed is set to the fifth level and an assist is requested. It may be allowed that the level of an obstacle state is selected through the monitoring apparatus 20 or the mobile body 600. In the case where the desired operation has been completed (YES in the step S408), information that the hitching operation has normally been completed is notified to the mission controller program 6841.

As described above, there is provided the automatic-driving normal-completion determination unit that operates based on the automatic-driving normal-completion determination program 6850 with which when automatic-driving operation related to moving or working, obtained by the working-information obtaining unit 12, ends, it is determined whether or not the automatic-driving operation has normally been completed; in the case where the automatic-driving normal-completion determination unit determines that the automatic-driving operation has not normally been completed, automatic-driving assisting processing for assisting the driving of the mobile body 600 is performed again; thus, even when instructed automatic-driving operation is not normally completed, the load on an assist performing person can be reduced and modified and hence a failure can be prevented.

### Embodiment 6

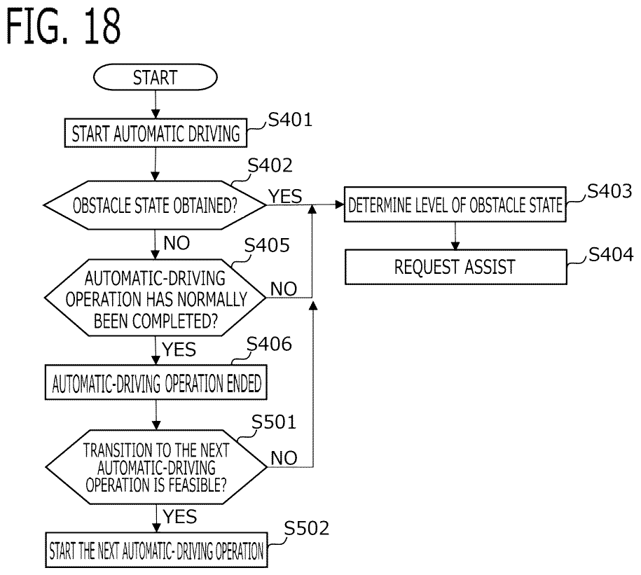

In Embodiment 6, there will be explained an example in which there is provided a function for determining whether or not the condition for controlling a state transition from the present automatic-driving operation to another automatic-driving operation is satisfied and in which in the case where transition to another automatic-driving operation cannot be made, it is determined that the automatic-driving operation cannot be continued and hence an assist is requested. FIG. 18 is a flowchart representing an outline flow of processing performed by the automatic-driving assisting system 1000 according to Embodiment 6. The flow—automatic-driving operation of the mobile body 600 is started (the step S401); in the case where an obstacle state is obtained (YES in the step S402), the obstacle state is determined (the step S403), and then an assist is requested (the step S404)—is the same as that in each of Embodiments 1 through 5. Embodiment 6 is different from each of Embodiments 1 through 5 in that in the case where objective automatic-driving operation has normally been completed, it is determined whether or not transition to the next automatic-driving operation can be made (the step S501). In the case where transition cannot be made (NO in the step S501), the step S403 where an obstacle stage is determined is resumed.

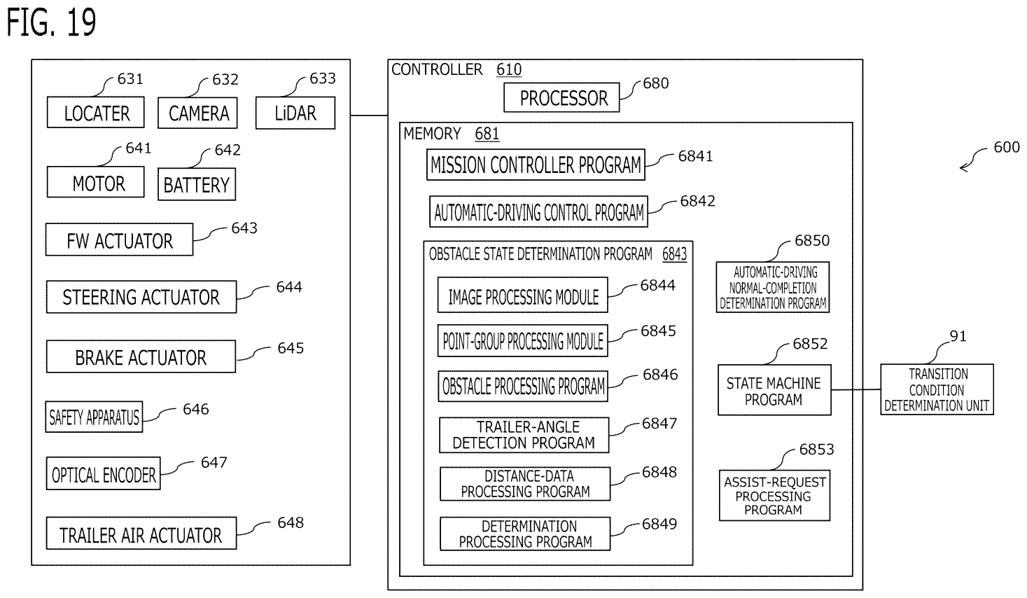

FIG. 19 is a schematic block diagram representing an example of the mobile body 600 according to Embodiment 6. In the present embodiment, the mobile body 600 is, for example, an autonomous tractor. As is the case with Embodiment 5, the mobile body 600 has the locator 631 for specifying a position, the camera 632 and the LiDAR 633 for obtaining peripheral-object information and the like, the motor 641 for driving the mobile body 600, and the controller 610 for instructing the control of respective mechanisms such as the battery 642 and the like and automatic-driving operation. The controller 610 has the processor 680 and the memory 681; the processor 680 executes programs stored in the memory 681. The memory 681 is provided with a state machine program 6852 for determining whether or not the condition for controlling a state transition from the present operation to another operation is satisfied, in addition to the configuration of Embodiment 5. The state machine program 6852 is executed by a transition condition determination unit 91.

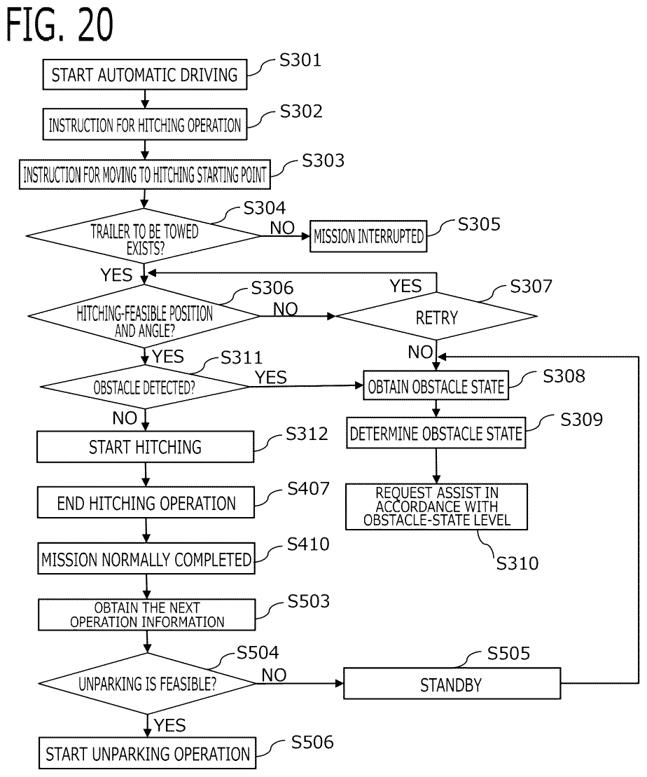

FIG. 20 is a flowchart representing an example of part of processing, for example, in executing hitching operation, performed by the automatic-driving assisting system 1000 through the mission controller program 6841. The steps S301 through S410 where a mission related to hitching operation is normally completed advance in a manner the same as that in Embodiment 5; thus, the explanation therefor will be omitted. When the present operation is normally completed (the step S410), next information is obtained (the step S503). For example, in the case where the next operation is unparking, it is determined whether or not the condition for transition to unparking operation is satisfied (the step S504). In the case where the condition enabling the unparking is not satisfied (NO in the step S504), the step S504 is followed by the step S308 where an obstacle state is obtained based on the next operation information. It may be allowed that the level of the obstacle state where the condition for controlling the state transition to another operation is not satisfied is set to the sixth level and then an assist is requested. It may be allowed that the level of an obstacle state is selected through the monitoring apparatus 20 or the mobile body 600.

In the case where the condition enabling the unparking is satisfied (YES in the step S504), the unparking operation as the next operation is started (the step S506) and then information that the transition to the unparking operation has normally been completed is notified to the mission controller program 6841.

In the step S504, the state where unparking cannot be performed is, for example, a case where the distance from the adjacent subject trailer 201 is small and hence the automatic-driving control is difficult. As is the case with the image analysis and the numerical analysis by the obstacle state determination unit 14, the cause of this state can be found. Therefore, the step S308 where an obstacle state is obtained is followed by the step S309 where the obstacle state is determined and then an assist is requested in accordance with the level of the obstacle state (the step S310), so that the obstacle can be avoided. For example, when the inter-vehicle distance required for automatic-driving control is, for example, 0.8 m and the present inter-vehicle distance is the same as or larger than 0.4 m but smaller than 0.8 m, the mobile body 600 performs basic operation items such as cognition, determination, and operation required in driving the mobile body 600; for example, the driving speed is lowered through assisting by the remote operator 501 and then there is performed unparking of the mobile body 600 towing the subject trailer 201 is made to leave from the parking place 301. In the case where the remote operator 501 determines that the parking position of the mobile body 600 towing the subject trailer 201 does not hinder the transition to the next automatic-driving operation, but the parking position of the adjacent trailer 202 poses a problem, it may be allowed that an instruction of making another mobile body move the adjacent trailer 202 is inputted to the mission controller program 6841.

When the distance from the adjacent trailer 202 is too small, for example the inter-vehicle distance is smaller than 0.4 m, a request for the remote-driving assist is issued to the remote-driving person 502. When the remote-driving person 502 determines that the remote driving is difficult, it may be allowed that the assist request is changed to the one for dispatching the dispatch worker 503 to the spot.

As described above, there is provided the transition condition determination unit 91 that determines the condition for transition to the next automatic-driving operation, in the case where there exist two or more automatic-driving operation items related to moving or working, obtained by the working-information obtaining unit 12, and the present automatic-driving operation has normally been completed; when the transition condition determination unit 91 determines that the transition to the next automatic-driving operation cannot be performed, automatic-driving assisting processing for assisting the driving of the mobile body, related to the next automatic-driving operation, is performed. Therefore, in the case where after operation or working has normally been completed, transition to the next operation cannot be performed, transition can smoothly be performed after the load on an assist performing person has been reduced.

In addition, each of Embodiments 1 through 6 has been explained with the tractor 100, as an example of the mobile body 6 or 600, that is a traction vehicle to which a trailer, as a cargo-loading vehicle on which cargos are loaded, is hitched and that tows the trailer; however, also in the case where a forklift that pulls cargos out of a truck, as a cargo-loading vehicle, by means of a fork is an example of the mobile body 6 or 600, the same effect can be demonstrated and a problem can be solved.

### <Summary of Respective Features in the Present Disclosure>

Hereinafter, the respective features in the present disclosure will collectively be described as appendixes.

(Appendix 1) An automatic-driving assisting apparatus for a mobile body that assists driving of a mobile body that moves cargos in a facility where conveyed cargos are stored, the automatic-driving assisting apparatus comprising:
a working-information obtaining unit that obtains a target position and a command for working;
an obstacle state obtaining unit that obtains an obstacle state hindering automatic-driving operation for at least any one of moving to a target position and working;
an obstacle state determination unit that determines to which one of levels the obstacle state obtained by the obstacle state obtaining unit belongs, wherein the levels are a first level at which an obstacle is avoided by automatic driving of the mobile body, a second level at which while automatic driving is continued under monitoring by a remote-monitoring person, the remote-monitoring person is made to perform automatic-driving assisting operation, a third level at which driving of the mobile body is performed through remote driving, and a fourth level at which dispatch of a dispatch worker for performing manual operation is requested; and an assist requesting unit that makes an assist request, when the obstacle state determination unit determines that the obstacle state belongs to any one of the second level, the third level, and the fourth level.

(Appendix 2) The automatic-driving assisting apparatus for a mobile body according to Appendix 1, wherein the obstacle state determination unit has at least one of an image analysis unit and a numerical-value analysis unit for analyzing image data and numerical data, respectively, obtained by the obstacle state determination unit and compares at least one of the image data and the numerical data with a reference data so as to determine to which one of the first level, the second level, the third level, and the fourth level, the obstacle state belongs.

(Appendix 3) The automatic-driving assisting apparatus for a mobile body according to any one of Appendixes 1 and 2, wherein the obstacle state determination unit determines to which one of the first level, the second level, the third level, and the fourth level the obstacle state belongs to, by use of two or more threshold values set with regard to the obstacle state.

(Appendix 4) The automatic-driving assisting apparatus for a mobile body according to any one of Appendixes 1 through 3, wherein the obstacle state obtaining unit utilizes, as the obstacle state, at least one of an obstacle on a moving route, a parking angle of a cargo-loading vehicle on which the cargos are loaded, a distance between the cargo-loading vehicle and an adjacent cargo-loading vehicle, the number of operational actions in each of which the mobile body has been hitched to the cargo-loading vehicle, the number of operational actions in each of which the cargo-loading vehicle has been docked to a carry-in port of the facility, and weather.

(Appendix 5) The automatic-driving assisting apparatus for a mobile body according to any one of Appendixes 1 through 4, wherein the obstacle state determination unit makes a determination in such a way that respective obstacle levels at the first level, at the second level, at the third level, and at the fourth level become higher in that order.

(Appendix 6) The automatic-driving assisting apparatus for a mobile body according to any one of Appendixes 1 through 5, further comprising an obstacle-avoidance performing unit that generates an action plan for avoiding an obstacle, when the obstacle state determination unit determines that the obstacle state belongs to the first level, and then makes the mobile body perform the automatic-driving operation based on the action plan.

(Appendix 7) The automatic-driving assisting apparatus for a mobile body according to any one of Appendixes 1 through 6, further comprising an automatic-driving normal-completion determination unit that determines, when automatic-driving operation related to the moving or the working, obtained by the working-information obtaining unit, ends, whether or not the automatic-driving operation has normally been completed,
wherein in the case where the automatic-driving normal-completion determination unit determines that the automatic-driving operation has not normally been completed, automatic-driving assisting processing for assisting driving of the mobile body is performed again.

(Appendix 8) The automatic-driving assisting apparatus for a mobile body according to any one of Appendixes 1 through 7, further comprising a transition condition determination unit that determines a condition for transition to the next automatic-driving operation, in the case where there exist two or more automatic-driving operation items related to the moving for the working, obtained by the working-information obtaining unit, and the present automatic-driving operation has normally been completed,
wherein when the transition condition determination unit determines that transition to the next automatic-driving operation cannot be performed, automatic-driving assisting processing for assisting the driving of the mobile body, related to the next automatic-driving operation, is performed.

(Appendix 9) An automatic-driving assisting system for a mobile body, comprising:
the automatic-driving assisting apparatus for a mobile body, mounted in the mobile body, according to any one of Appendixes 1 through 8; and
a monitoring apparatus having
   a positional-information obtaining unit that obtains respective positional information items on a cargo-loading vehicle on which the cargos are loaded and the mobile body,
   a command unit that selects a subject cargo-loading vehicle among a plurality of the cargo-loading vehicles and issues a command for making the mobile body move to a parking position of the subject cargo-loading vehicle and carry the cargos, and
   an assist-performing unit that responds to assist requests in such a way as to remotely operate the mobile body, when an assist for remote operation is requested by the automatic-driving assisting apparatus, to remotely drive the mobile body, when an assist for remote driving is requested, and to request dispatch of a dispatch worker, when an assist for manual operation is requested.

(Appendix 10) An automatic-driving assisting system for a mobile body, comprising:
the automatic-driving assisting apparatus for a mobile body, mounted in the mobile body, according to any one of Appendixes 1 through 8, the automatic-driving assisting apparatus including
   a command inputting unit for inputting a target position and a command for working,
   a positional-information comprehending unit that comprehends the target position,
   an action plan generation unit that generates an action plan, based on working information inputted by the command inputting unit and positional information for the target position comprehended by the positional-information comprehending unit, and making the mobile body perform the automatic-driving operation, based on the generated action plan; and
a monitoring apparatus having
   an assist-performing unit that responds to assist requests in such a way as to remotely operate the mobile body, when an assist for remote operation is requested by the automatic-driving assisting apparatus, to remotely drive the mobile body, when an assist for remote driving is requested, and to request dispatch of a dispatch worker, when an assist for manual operation is requested.

(Appendix 11) The automatic-driving assisting apparatus for a mobile body according to any one of Appendixes 9 and 10, wherein the monitoring apparatus has an assist request changing unit that changes the assist requests from the mobile body.

(Appendix 12) A monitoring apparatus for a mobile body, comprising:
the automatic-driving assisting apparatus according to any one of Appendixes 1 through 8;
a positional-information obtaining unit that obtains respective positional information items on a cargo-loading vehicle on which the cargos are loaded and the mobile body;
a command unit that selects a subject cargo-loading vehicle among a plurality of the cargo-loading vehicles and issues a command for making the mobile body move to a parking position of the subject cargo-loading vehicle and carry the cargos; and
an assist-performing unit that responds to assist requests, with regard to an obstacle state hindering automatic-driving operation corresponding to the command, in such a way as to remotely operate the mobile body, when an assist for remote operation is requested, to remotely drive the mobile body, when an assist for remote driving is requested, and to request dispatch of a dispatch worker, when an assist for manual operation is requested.

(Appendix 13) An automatic-driving assisting method, for a mobile body, that assists driving of a mobile body that moves cargos in a facility where conveyed cargos are stored, the automatic-driving assisting method comprising:
a step of obtaining a target position and a command for working;
a step of obtaining an obstacle state hindering automatic-driving operation for at least any one of moving to the target position and the working;
a step of determining to which one of levels the obtained obstacle state belongs, wherein the levels are a first level at which an obstacle is avoided by automatic driving of the mobile body, a second level at which while automatic driving is continued under monitoring by a remote-monitoring person, the remote-monitoring person is made to perform automatic-driving assisting operation, a third level at which driving of the mobile body is performed through remote driving by a monitoring apparatus, and a fourth level at which dispatch of a dispatch worker for performing manual operation is requested; and
a step of making an assist request, when it is determined that the obstacle state belongs to any one of the second level, the third level, and the fourth level.

Although the present disclosure is described above in terms of various exemplary embodiments, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the specification of the present disclosure. For example, there are included the case where at least one constituent element is modified, added, or omitted and the case where at least one constituent element is extracted and then combined with constituent elements of other embodiments.

### REFERENCE SIGNS LIST

6, 600: mobile body, 10: automatic-driving assisting apparatus, 11: working-command receiving unit, 12: working-information obtaining unit, 13: obstacle state obtaining unit, 14: obstacle state determination unit, 15: assist requesting unit, 16: obstacle-avoidance performing unit, 17: vehicle control unit, 18: command inputting unit, 19: action plan generation unit, 20: monitoring apparatus, 21: remote operation apparatus, 22: remote-driving apparatus, 23: working plan creation unit, 24: mobile body selection unit, 25: trailer selection unit, 26: moving-route creation unit, 27: positional-information obtaining unit, 28: command unit, 29: assist-performing unit, 30: monitoring camera, 31, 311: position receiver, 51: modified moving route, 52, 53: obstacle, 61: control instruction unit, 63: sensor, 64: vehicle-driving control unit, 66: control calculation unit, 68: automatic-driving operation instruction unit, 69: automatic-driving control unit, 70: peripheral-environment-information processing unit, 80, 680: processor, 81: memory, 90: automatic-driving normal-completion determination unit, 91: transition condition determination unit, 100: tractor, 141: image analysis unit, 142: numerical-value analysis unit, 143: calculation unit, 144: reference-data storage unit, 145: determination unit, 200: trailer, 201: subject trailer, 202: adjacent trailer, 271: positional-information comprehending unit, 301, 302: parking place, 400: building, 401: carry-in port, 501: remote operator, 502: remote-driving person, 503: dispatch worker, 1000: automatic-driving assisting system, 4000: distribution center

What is claimed is:

1. An automatic-driving assisting apparatus for a mobile body that assists driving of a mobile body that moves cargos in a facility where conveyed cargos are stored, the automatic-driving assisting apparatus comprising at least one processor configured to implement:
a working-information obtainer that obtains a target position and a command for working;
an obstacle state obtainer that obtains an obstacle state hindering automatic-driving operation for at least any one of moving to the target position and the working;
an obstacle state determiner that determines to which one of levels the obstacle state obtained by the obstacle state obtainer belongs, wherein the levels are a first level at which an obstacle is avoided by automatic driving of the mobile body, a second level at which while automatic driving is continued under monitoring by a remote-monitoring person, the remote-monitoring person is made to perform automatic-driving assisting operation, a third level at which driving of the mobile body is performed through remote driving, and a fourth level at which dispatch of a dispatch worker for performing manual operation is requested; and
an assist requestor that makes an assist request, when the obstacle state determiner determines that the obstacle state belongs to any one of the second level, the third level, and the fourth level.

2. The automatic-driving assisting apparatus for a mobile body according to claim 1, wherein the obstacle state determiner has at least one of an image analyzer and a numerical-value analyzer for analyzing image data and numerical data, respectively, obtained by the obstacle state determiner and compares at least one of the image data and the numerical data with a reference data so as to determine to which one of the first level, the second level, the third level, and the fourth level, the obstacle state belongs.

3. The automatic-driving assisting apparatus for a mobile body according to claim 1, wherein the obstacle state determiner determines to which one of the first level, the second level, the third level, and the fourth level the obstacle state belongs to, by use of two or more threshold values set with regard to the obstacle state.

4. The automatic-driving assisting apparatus for a mobile body according to claim 1, wherein the obstacle state obtainer utilizes, as the obstacle state, at least one of an obstacle on a moving route, a parking angle of a cargo-loading vehicle on which the cargos are loaded, a distance between the cargo-loading vehicle and an adjacent cargo-loading vehicle, the number of operational actions in each of which the mobile body has been hitched to the cargo-loading vehicle, the number of operational actions in each of which the cargo-loading vehicle has been docked to a carry-in port of the facility, and weather.

5. The automatic-driving assisting apparatus for a mobile body according to claim 1, wherein the obstacle state determiner makes a determination in such a way that respective obstacle levels at the first level, at the second level, at the third level, and at the fourth level become higher in that order.

6. The automatic-driving assisting apparatus for a mobile body according to claim 1, further comprising an obstacle-avoidance performer that generates an action plan for avoiding an obstacle, when the obstacle state determiner determines that the obstacle state belongs to the first level, and then makes the mobile body perform the automatic-driving operation based on the action plan.

7. The automatic-driving assisting apparatus for a mobile body according to claim 1, further comprising an automatic-driving normal-completion determiner that determines, when automatic-driving operation related to the moving or the working, obtained by the working-information obtainer, ends, whether or not the automatic-driving operation has normally been completed,
wherein in the case where the automatic-driving normal-completion determiner determines that the automatic-driving operation has not normally been completed, automatic-driving assisting processing for assisting driving of the mobile body is performed again.

8. The automatic-driving assisting apparatus for a mobile body according to claim 1, further comprising a transition condition determiner that determines a condition for transition to the next automatic-driving operation, in the case where there exist two or more automatic-driving operation items related to the moving or the working, obtained by the working-information obtainer, and the present automatic-driving operation has normally been completed,
wherein when the transition condition determiner determines that transition to the next automatic-driving operation cannot be performed, automatic-driving assisting processing for assisting the driving of the mobile body, related to the next automatic-driving operation, is performed.

9. An automatic-driving assisting system for a mobile body, comprising:
the automatic-driving assisting apparatus for a mobile body, mounted in the mobile body, according to claim 1; and
a monitoring apparatus having
a positional-information obtainer that obtains respective positional information items on a cargo-loading vehicle on which the cargos are loaded and the mobile body,
a commander that selects a subject cargo-loading vehicle among a plurality of the cargo-loading vehicles and issues a command for making the mobile body move to a parking position of the subject cargo-loading vehicle and carry the cargos, and
an assist-performer that responds to assist requests in such a way as to remotely operate the mobile body, when an assist for remote operation is requested by the automatic-driving assisting apparatus, to remotely drive the mobile body, when an assist for remote driving is requested, and to request dispatch of a dispatch worker, when an assist for manual operation is requested.

10. The automatic-driving assisting system according to claim 9, wherein the monitoring apparatus has an assist request changer that changes the assist requests from the mobile body.

11. An automatic-driving assisting system for a mobile body, comprising:
the automatic-driving assisting apparatus for a mobile body, mounted in the mobile body, according to claim 1, the automatic-driving assisting apparatus including
a command inputter for inputting a target position and a work command,
a positional-information comprehender that comprehends the target position,
an action plan generator that generates an action plan, based on working information inputted by the command inputer and positional information for the target position comprehended by the positional-information comprehender, and making the mobile body perform the automatic-driving operation, based on the generated action plan; and
a monitoring apparatus having
an assist-performer that responds to assist requests in such a way as to remotely operate the mobile body, when an assist for remote operation is requested by the automatic-driving assisting apparatus, to remotely drive the mobile body, when an assist for remote driving is requested, and to request dispatch of a dispatch worker, when an assist for manual operation is requested.

12. A monitoring apparatus for a mobile body, comprising:
the automatic-driving assisting apparatus according to claim 1;
a positional-information obtainer that obtains respective positional information items on a cargo-loading vehicle on which the cargos are loaded and the mobile body;
a commander that selects a subject cargo-loading vehicle among a plurality of the cargo-loading vehicles and issues a command for making the mobile body move to a parking position of the subject cargo-loading vehicle and carry the cargos; and
an assist-performer that responds to assist requests, with regard to an obstacle state hindering automatic-driving operation corresponding to the command, in such a way as to remotely operate the mobile body, when an assist for remote operation is requested, to remotely drive the mobile body, when an assist for remote driving is requested, and to request dispatch of a dispatch worker, when an assist for manual operation is requested.

13. An automatic-driving assisting method, for a mobile body, that assists driving of a mobile body that moves cargos in a facility where conveyed cargos are stored, the automatic-driving assisting method comprising:
obtaining a target position and a command for working;
obtaining an obstacle state hindering automatic-driving operation for at least any one of moving to the target position and the working;
determining to which one of levels the obtained obstacle state belongs, wherein the levels are a first level at which an obstacle is avoided by automatic driving of the mobile body, a second level at which while automatic driving is continued under monitoring by a remote-monitoring person, the remote-monitoring person is made to perform automatic-driving assisting operation, a third level at which driving of the mobile body is performed through remote driving by a monitoring apparatus, and a fourth level at which dispatch of a dispatch worker for performing manual operation is requested; and
making an assist request, when it is determined that the obstacle state belongs to any one of the second level, the third level, and the fourth level.
